(19) United States
(12) Patent Application Publication
(10) Pub. No.: US 2004/0128240 A1
(43) Pub. Date: Jul. 1, 2004

(54) Method and system for managing financial transactions

(76) Inventor: Wendy E. Yusin, New York, NY (US)

Correspondence Address: Brandon N. Sklar, Kaye Scholer LLP, 425 Park Avenue, New York, NY, 10022-3598, US

(21) Appl. No.: 10/680,892

(22) Filed: Oct. 7, 2003

Related U.S. Application Data
(63) Continuation of application No. 60/416,633, filed on Oct. 7, 2002.

(51) Int. Cl. G06F 17/60

(52) U.S. Cl. 705/39; 705/42

(57) ABSTRACT

A method of processing a cash transfer by or on behalf of a first entity to a bank account of a second entity comprises receiving information related to the cash transfer and formatting the information into one of a plurality of formats based, at least in part, on a location of the bank account. The information may be formatted into a NACHA format, if the bank account is in the United States, or a UN/EDIFACT format, if the bank account is not in the U.S. Information related to the country where the bank account is located may be added to the formatted information, to facilitate and enable clearance and settlement of funds in that country. A clearing network may be selected for the clearance and settlement of the funds. Information about the second entity may be previously received and stored in memory, for comparison to currently received information about the second entity in a current transaction, to detect fraud. Systems are disclosed, as well.

The present application claims the benefit of application Ser. No. 60/416,633, filed on Oct. 7, 2002, which is incorporated by reference herein.

### FIELD OF THE INVENTION

A method and system for managing financial transactions and, more particularly, a method and system for managing and monitoring cash transfers, throughout the world.

### BACKGROUND OF THE INVENTION

FIG. 1 is a schematic diagram of a prior art credit card transaction system 10 in the United States. When a credit card transaction is processed, data required to effectuate (or settle) the transaction is entered, a request for authorization to complete the transaction (based on the transaction data) is generated, an authorization is either granted or denied, and if authorization is granted, necessary funds to effectuate the transaction are transferred. Such a transaction typically involves multiple parties including a Credit Card Holder 12, an Acquiring Bank 14, a Merchant 16, a Bank Card Association 18, and an Issuing Bank 20. While only one of each party is shown for ease of illustration, it is understood that there is a plurality of each party in a credit card transaction system.

The Credit Card Holder 12 is an entity, such as a person or business, that purchases goods or services from the Merchant 16 using a credit card issued by the Issuing Bank 20. The Merchant 16 is an entity, such as a business or person, that sell goods or services and is able to accept and charge credit cards to complete the sale. The Merchant 16 may be a point of sale Merchant.

The Bank Card Association 18 is a credit card payment service association (such as Visa and MasterCard) that is made up of member financial institutions. The Bank Card Association 18, among other things, sets and enforces rules governing their credit cards and conducts clearing and settlement processing. The Bank Card Association 18 neither issues cards nor signs merchants. Instead, it licenses financial institutions, such as the Issuing Bank 20, to issue cards, and licenses the Acquiring Bank 14 to acquire merchants' sales drafts under the Association's brand name. The Bank Card Association 18 then manages the transfer of transaction data and funds between the Issuing Bank 20 and the Acquiring Bank 14. In addition, the Bank Card Association 18 maintains national and international networks through which data and funds are moved between the Credit Card Holder, the Merchant 16, the Acquiring Banks 14 and the Issuing Bank 20.

The Acquiring Bank 14 is an entity that owns the legal relationship with the Merchant 16. The Bank 14 buys (acquires) the rights to the sales slips of the Merchant 16 and credits the value of the sales slip to the Merchant's account at the Bank. The Acquiring Bank 14 effectuates payment to the Merchant 14 upon authorization of a credit card transaction and charges the Merchant 14 a fee for handling each transaction. The Issuing Bank 20 issues credit cards to approved Card Holders, such as Card Holder 12, receives and pays for transactions from the Bank Card Association 18 and sends bills to and collects payment from the Credit Card Holder 12.

A Platform 22 serves as the liaison between the Merchant 16 and the Bank Card Association 18. The Platform 22 seeks authorization for the credit card transaction and conveys the authorization or rejection to the Merchant 16. The Platform also computes the interchange fees associated with each credit card transaction processed by the Merchants 16 in accordance with predetermined business rules established by the Bank Card Associations 18.

Thus, suppose the Issuing Bank 20 issues a credit card to the Credit Card Holder 12 (A). The Credit Card Holder makes a $50.00 purchase at a Merchant 16 (B). Upon inputting transaction data, the Merchant 16 requests authorization from the Platform 22 (C). The Platform requests authorization from a Bank Card Association 18 (D) and ultimately the Issuing Bank 20 (E). The request for authorization is transmitted from the Merchant 16 to the Issuing Bank 20 through the Platform 22 and Bank Card Association 18. The resulting authorization (or rejection) (F) is then issued by the Issuing Bank 20a and transmitted back to the Merchant 16 through the Bank Card Association 18 (G) and the Platform 22 (H).

Upon completion of the transaction, the Merchant 16, at some subsequent point in time, is paid the transaction price by the Acquiring Bank 14 (J) that has purchased the rights to the Merchant's sales slips (J). The Acquiring Bank 14 receives payment from the Issuing Bank 20 (K). The Acquiring Bank 14 and the Issuing Bank 20 typically have their own clearing networks to effectuate their payments.

Individual countries often have their own clearing networks, formats for processing transactions and funding requirements. As mentioned above, in the United States, clearing networks follow the NACHA format. In England, clearing networks follow the Bankers Automated Clearing Service, Ltd., (“BACS”) format. In Canada, clearing networks follow a Canadian Payments Association (“CPA”) format. There is an international standard, the United Nations Electronic Data Exchange Administration, Commerce and Transport UN/EDIFACT format, for electronic data exchange including financial transactions, such as payment settlement, around the world. However, the UN/EDIFACT format does not include certain information and formatting required for financial institutions in particular countries. Therefore, when dealing with transactions outside of the U.S., merchants and other entities that need to be paid in a currency other than U.S. dollars and/or need money transferred to a bank account outside of the U.S., must separately arrange for the movement of cash in each country in which it transacts business, with financial institutions in each respective country. Such financial institutions may include banks and clearing houses, for example. File formats in each country must be conformed to, typically by working with the local financial institution that works with the local requirements. Institutions may use proprietary software to provide this function.

One example of a detail related to money transfer that varies from country to country is the threshold for a monetary value above which money must be transferred by wire transfer. High value money transfers involving monetary values above the threshold must be conducted by wire transfer. Low value money transfers involving monetary values at or below the threshold are typically conducted through an automated clearing house. For example, in Germany, money values over 25,000 Euros are considered to be high value and must be transferred by wire. The parties to the transaction may request wire transfer for monetary values below the threshold, as well.

Countries may also have different cut off time frames within which money transfers must be completed on a particular day. If money transfer is not completed by the cut off time, the money transfer is deferred until the next day.

Countries also have different regulations for when a party must be paid. Time frames may vary from 4-5 days, for example. Banks in different countries may also be open on different days. For example, banks in Israel are open on Sundays. Banks in Muslim countries may be closed on Fridays. Some banks in the United States may be open on weekends, as well.

A plurality of clearing houses are available. When a choice of clearing house is available, use of a particular clearing house is dictated by the financial institutions involved, many of which have their own clearing networks. ABN AMRO Bank, Amsterdam, Netherlands, J. P. Morgan Chase, New York, N.Y., Standard Charter, New York, N.Y., the U.S. Federal Reserve, and foreign Federal Reserves, are examples of clearing houses.

The clearing house and associated banks in a particular country may also have different information, format and security requirements. For example, file encryption using secure keys may be required. Router codes to convey the file to the financial institution may be required, as well.

Fraud is an ever present problem in cash transfer transactions. A known scheme in the credit card environment, for example, is for point of service merchants to inflate sales charges to customers using credit cards, for products that have not been purchased. The merchant will typically be paid before the customer receives a statement and has an opportunity to question the charge. After the merchant receives the payment, the merchant closes the bank account into which the payment was made. Once the account is closed, it is difficult for the credit card company to retrieve a payment for an improper charge.

It is also typical in the United States and around the world that when the debit and credit files are sent by ACH, payment is assumed, unless a non-payment notice is received by the merchant or other party or body involved in the transaction. This can lead to inaccurate accounting by the party expecting the payment, who cannot know what their true balance is at any point in time.

### SUMMARY OF THE INVENTION

In accordance with an embodiment of the invention, a method of managing a cash transfer by or on behalf of a first entity to an account of a second entity is disclosed comprising receiving information related to the cash transfer and formatting the information into one of a plurality of formats based, at least in part, on a location of the account. The account may be a bank account. The location of the account may be the country where the account is located. If the account is located in the United States, the information may be formatted in an National Automatic Clearing House Association (NACHA) format, for example. If the account is located outside of the United States, the information may be formatted in a United Nations Electronic Data Exchange Administration, Commerce and Transport (UN/EDIFACT) format, for example. Country specific information, including required data and formatting, may be added to the formatted information to tailor the information for clearance and settlement of funds in the particular country where the second entity's account is located. The information may be provided from a platform chosen from the group consisting of a credit card processor, a bank, a business-to-business gateway for electronic fund transfer, a business-to-consumer gateway for electronic fund transfer or a consumer-to-business gateway for electronic fund transfer, for example. The cash transfer may relate to a transaction between the first and second entities such as a credit card transaction, a debit card transaction, a payment by check, an electronic funds transfer and a wire payment between the first and second entities.

The country specific data may include any or all of the following, for example. A time beyond which cash transfer cannot take place may be determined for a particular country, and that time may be added to the formatted information. A value date for money transfer in that country, by which date money must be transferred into the account, may be determined and added to the formatted information. A threshold for a monetary value above which a cash transfer must take place by wire transfer may be determined and used to determine whether the cash must be transferred by wire transfer or could be transferred by a low value clearing, and an indication of an acceptable mode of transfer of the cash transfer may be added to the formatted information based, at least in part, on the threshold. One of a plurality of clearing networks may be selected to clear and settle the cash transfer and added to the formatted information.

Information about the second entity may be stored in memory for comparison to received information about the second entity in the information related to the cash transfer. The stored information and the received information may be compared. Differences in information, such as bank accounts and entity names, may be indicative of fraud. Processing of the cash transfer may be stopped and/or the party providing the information about the cash transfer may be notified.

The cash transfer may relate to a transaction between the first and second entities such as a credit card transaction, a debit card transaction, a payment by check, an electronic funds transfer and a wire payment between the first and second entities.

In accordance with another embodiment of the invention, a method of managing cash transfers by or on behalf of at least one first entity to a bank account of at least one respective second entity is disclosed comprising receiving information related to the cash transfer in the form of a file comprising at least one record related to a respective cash transfer, from a party. The method formats the information in the at least one record into one of a plurality of formats based, at least in part, on a country where the bank account of the second entity related to the cash transfer of the record is located, to form a formatted record. The method then sends a file comprising at least one formatted record to a clearing network.

In accordance with another embodiment of the invention, a method of managing cash transfers by or on behalf of at least one first entity to a bank account of at least one respective second entity is disclosed comprising receiving information about a second entity, from a party and storing the received information about the second entity. The method receives information related to the cash transfer in the form of a file comprising at least one record related to a respective cash transfer, and compares the received information about the second entity to the stored information. As discussed above, this method may help detect changes in information such as bank account numbers and entity names, that could be fraudulent.

In accordance with another embodiment of the invention, a method of managing cash transfers by or on behalf of at least one first entity to a bank account of at least one respective second entity is disclosed comprising receiving information related to the cash transfer in the form of a file comprising at least one record related to a respective cash transfer, from a party. The method sends the information to a clearing network to clear and settle the cash transfer. The method receives information from the clearing network concerning a status of the clearance and settlement of the cash transfer and informs the party of the status. The party may be a platform, as discussed above. This method enables the platform or other such party to learn of the status of the cash transfer so that its accounting information may be kept current. The second entity may also be learn of the status from the platform, which assists the second entity in its accounting. The method may also inform a second party contractually associated with the first entity or the second entity with respect to cash transfer, of the status.

In accordance with another embodiment of the invention, a method of managing cash transfers by or on behalf of at least one first entity to a bank account of at least one respective second entity is disclosed comprising receiving information related to a cash transfer in the form of a file comprising at least one record related to a respective cash transfer, processing the record, receiving a request for access to status information related to the status of the processing of the record and selectively granting access to the status information. The method may further comprise sending the record to a clearing network to clear and settle the cash transfer, receiving information from the clearing network concerning a status of the clearance and settlement of the cash transfer and allowing access to information about the status of the processing of the record by the clearing network, to the at least one selected party. The selected party may be contractually associated with the first party or the second party with respect to the cash transfer.

In accordance with another embodiment, a system for managing a cash transfer by or on behalf of a first entity to an account of a second entity is disclosed comprising means for receiving information related to the cash transfer and means for formatting the information into one of a plurality of formats based, at least in part, on a location of the account.

In accordance with another embodiment of the invention, a system to manage a cash transfer by or on behalf of a first entity to an account of a second entity is disclosed comprising memory to store information related to the cash transfer and a processor coupled to the memory. The processor is programmed to format the information into one of a plurality of formats based, at least in part, on a location of the account. The account may be a bank account and the location may be a country where the account is located.

In accordance with another embodiment, a system to manage cash transfers by or on behalf of at least one first entity to a bank account of at least one respective second entity is disclosed comprising an interface to receive information related to the cash transfer in the form of a file comprising at least one record related to a respective cash transfer, from a party. The system also comprises memory to store the file and a processor coupled to the interface and to the memory. The processor is programmed to format the information in the at least one record into one of a plurality of formats based, at least in part, on a country where the bank account of the second entity related to the cash transfer of the record is located, to form a formatted record. The processor is also programmed to send a file comprising at least one formatted record to a clearing network, via the interface.

In accordance with another embodiment of the invention, a system to manage cash transfers by or on behalf of at least one first entity to a bank account of at least one respective second entity is disclosed comprising an interface to receive information about a second entity, from a party, and information related to the cash transfer in the form of a file comprising at least one record related to a respective cash transfer, from the party. The system further comprises memory to store the information about the second entity and the information about the cash transfer. The system further comprises a processor coupled to the interface and to the memory. The processor is programmed to compare the information about the second entity to the information about the cash transfer to identify differences in the same type of information. As discussed above, this can help detect fraud.

In accordance with another embodiment of the invention, a system to manage cash transfers by or on behalf of at least one first entity to a bank account of at least one respective second entity is disclosed comprising an interface to receive information related to the cash transfer in the form of a file comprising at least one record related to a respective cash transfer, from a party. The system further comprises memory to store the received information. The system further comprises a processor coupled to the interface and to the memory. The processor is programmed to send the information to a clearing network to clear and settle the cash transfer and to inform the party of a status of the clearance and settlement of the cash transfer.

In accordance with another embodiment of the invention, a system to manage cash transfers by or on behalf of at least one first entity to a bank account of at least one respective second entity is disclosed comprising an interface to receive information related to the cash transfer in the form of a file comprising at least one record related to a respective cash transfer, from a party. The system further comprises memory to store the received information and a processor coupled to the interface and to the memory. The processor is programmed to process the record for cash transfer and allow access to information about the status of the processing of the record by the system, to at least one selected party. The processor may be further programmed to send the information to a clearing network to clear and settle the cash transfer and inform the party of the status of the clearance and settlement based on information received from the clearing network. The selected party may be contractually associated with the first entity or the second entity with respect to the cash transfer,

### BRIEF DESCRIPTION OF THE FIGURES

FIG. 1 is a schematic diagram of a prior art credit card transaction system in the United States;

FIG. 2 is an example of a Financial Transaction Clearing System for U.S. and/or international cash transfers that may implement embodiments of the present invention;

FIG. 3 is a block diagram of a Transaction Manager in accordance with an embodiment of the invention;

FIG. 4 is a simplified representation of the System of FIG. 1, showing certain of the file transfers and file conversions discussed herein;

FIG. 5 is an example of a method of operation of the Financial Transaction Clearing System of FIG. 1;

FIG. 6 is an example of a method of managing transactions in accordance with an embodiment of the invention;

FIG. 7 is an example of a method for generating a Worldwide Funding File in accordance with an embodiment of the present invention;

FIG. 8 is a continuation of the method of FIG. 6;

FIG. 9 is a continuation of the method of FIG. 5;

FIG. 10 is an example of another method of in accordance with another embodiment of the invention;

FIG. 11 is a continuation of the method of FIGS. 5 and 9;

FIG. 12 is a continuation of the method of FIG. 10; and

FIG. 13 is an example of a method of another embodiment of the invention.

### DETAILED DESCRIPTION OF THE PREFERRED EMBODIMENTS

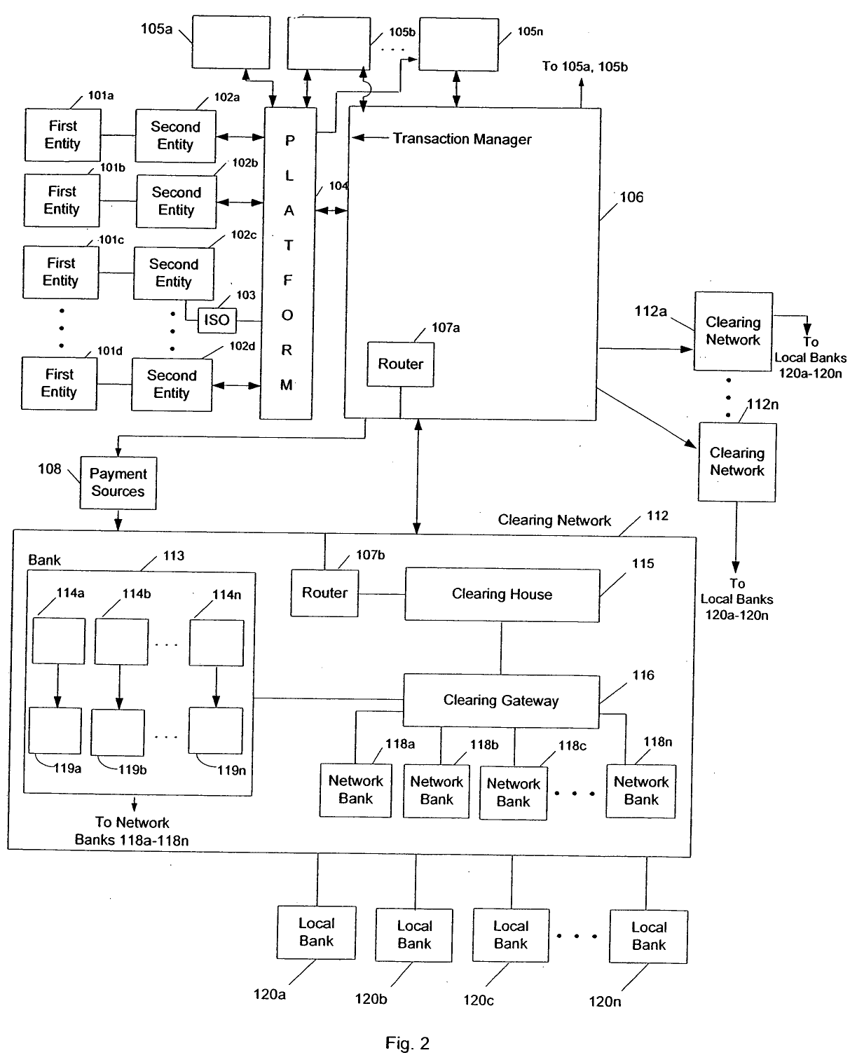

FIG. 2 is an example of a Financial Transaction Clearing System 100 for U.S. and/or international cash transfers that may implement embodiments of the present invention. The System 100 authorizes and effectuates the cash transfer from or on behalf of first entities 101a, 101b, 101c . . . . 101n, which may be consumers, businesses, and banks, for example, to second entities 102a-102n, which may be businesses, such as point of sale (“POS”) merchants, individuals, banks, independent service organizations (“ISOs”), or agents, for example, in exchange for the sale of goods or the performance of services. The first entities 101a-101n and the second entities may be located anywhere in the world. The cash transfer may be initiated through a credit card transaction, a debit card transaction, a check, an electronic check payment, an electronic funds transfer, a wire payment, etc.

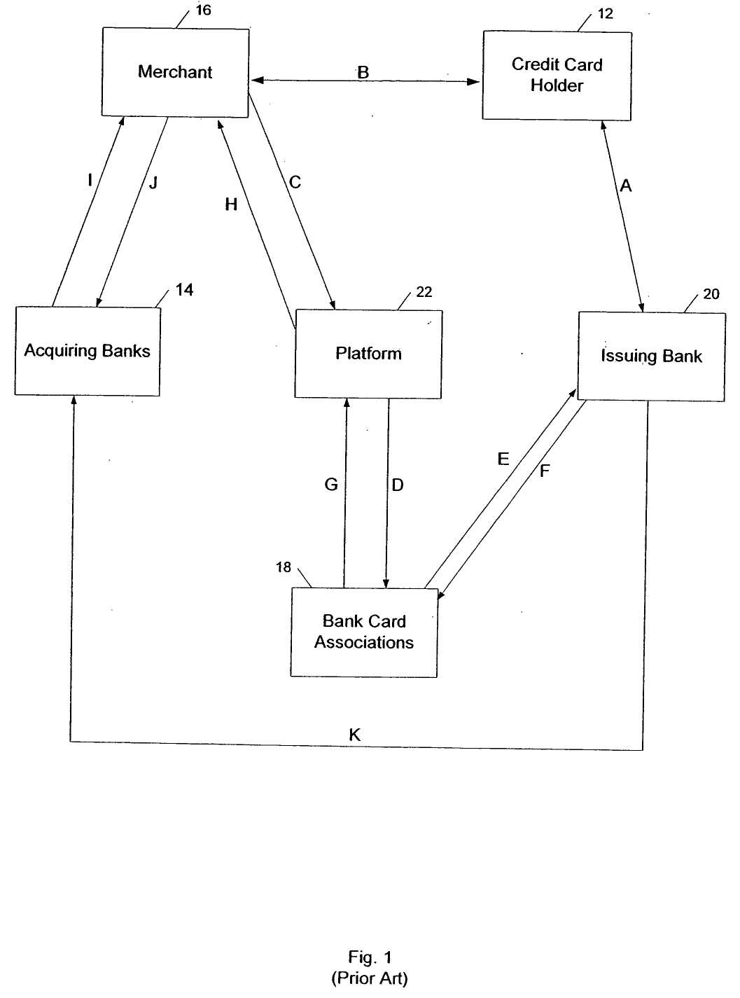

Institutions 105a, 105b . . . 105n are typically contractually obligated to the first or second entities 101a-101n, 102a-102n, whereby they own and manage the legal relationships with the first and second entities 101a-101n, 102a-102n. In the context of credit card transactions, Institutions may include Issuing Banks and Acquiring Banks (see FIG. 1). Wells Fargo Merchant Services, San Francisco, Calif. is an example of such an Institution. In electronic fund transfers, the Institution may be a second entity 102a-102n that is large enough to perform this function on its own behalf and banks. Large organizations may assume the role of the Institutions 105a-105n in electronic fund transfers.

To clear and settle cash transfers in any form (other than direct cash payments) from the first entity 110a, for example, to the second entity 102a, for example, details related to the cash transfer are initially processed by a Platform 104, as discussed above with respect to FIG. 1. In accordance with an embodiment of the invention, the information is further processed by a Transaction Manager (“TM”) 106, which, among other functions, converts the information into an appropriate format dependent upon whether the file is for U.S. transactions or international transactions, as is described in more detail, below. In this embodiment of the invention, U.S. transactions are those in which the bank account of the second entity 102a-102n to which the cash is to be transferred is located in the United States and the currency of payment is U.S. dollars. International transactions in this embodiment are those in which the bank account of the second entity is located outside of the U.S. and/or the currency is not U.S. dollars.

Funds to settle the cash transfer may be provided by Payment Sources 108, which may be bank accounts of Acquiring Banks and Issuing Banks, credit card companies, debit card companies, etc. The funds are provided to one of a plurality of Clearing Networks 112, 112a . . . 112n, here, Clearing Network 112, for example, which moves the funds to a bank account of the second entity 102a, based on instructions from the TM 106. The internal structures of the Clearing Networks 112a-112n, which are not shown to ease illustration, are the same as shown for the Clearing Network 112. The funds to be transferred to the second entity 102a may be kept in a Bank 113, in respective Cash Accounts 114a, 114b . . . 114n within the Clearing Network 112. Preferably, separate Cash Accounts 114a-114n are provided for each currency that may be cleared by the Clearing Network 112. The Clearing Network 112 may cause the money to be moved from an appropriate one of the Cash Accounts 114a-114n or from an appropriate one of the Payment Sources 108 into the bank account of the second entity 102a. The account of the second entity 102a may be in one of a plurality of Network Beneficiary Banks 118a, 118b, 118c . . . 118n that is part of the Clearing Network 112, or in one of a plurality of Local Beneficiary Banks 120a, 120b, 120c . . . 120n, via an appropriate Network Bank. The Network Beneficiary Banks 118a-118n are located in respective countries throughout the world where the System 100 can clear and settle funds. One or more Local Beneficiary Banks 120a-120n are also located in countries around the world.

While one Platform 104 is shown, the system 10 may comprise a plurality of Platforms. The second entities 102a-102n may provide information related to the cash transfer to the Platform 104 with which it has contracted to start to process details related to the transfer. Transaction details may be provided from the second entities 102a-102n to the Platform 104 in a Transaction File via a File Transfer Protocol (“FTP”), for example. The Platform 104 and the TM 106 are preferably connected via a direct telecommunications connection. They may be connected via the Internet or an Intranet, as well. One or a plurality of transactions may be described in the Transaction File. The Platform 104 may be a credit card processor, a bank, a business-to-consumer, business-to-business and/or consumer-to-business gateway for electronic fund transfers, or other such party, which are known in the art. Second entities 102a-102n that are POS merchants may also seek authorization for individual credit card and debit card transactions via the Platform 104, as discussed above with respect to FIG. 1. The second entities 102a-102n may provide the information directly to the Platform 104 or through an intermediary, such as a bank or ISO 130, with a relationship with a respective second entity 102c, for example, as is known in the art. The Platform 104 may comprise either or both of First Data Merchant Services (“FDMS”), Coral Springs, Fla. and Omnipay Ltd., Dublin, Ireland. Omnipay Ltd. may be the international processing partner of FDMS, for example.

The Platform 104 generates a Basic Funding File including relevant information provided to the Platform 104 by the second entities 102a-102n, for one or more transactions (cash transfers). The Basic Funding File typically identities the parties to a transaction (the first entity 101a and the second entity 102a, for example), the cash value of the transaction, the date and time of the transaction, the currency of the transaction, identifying information of the bank and bank account of the second entity 102b where the money is to be transferred, the date of receipt by the Platform 104 of the transaction details, the currency of the transaction, the Institution 105a-105n owning or otherwise contractually related to the transaction, and other details related to the transaction, as is known in the art. Information related to each transaction is described in a respective Detail Record in the Basic Funding File. The Detail Records in the Basic Funding File may be from one or a plurality of entities 102a-102n and from one or a plurality of Transaction Files. The Platform 104 also preferably determines whether the transaction is a U.S. transaction or an international transaction, based on the criteria described above, for example. Such information is typically provided in each Detail Record in the Basic Funding File. U.S. transactions and international transactions may be included in the same or different Basic Funding Files.

In accordance with an embodiment of the invention, the Basic Funding File is sent to the Transaction Manager (“TM”) 106, which checks the Basic Funding File for errors and converts the Detail Records in the File into an appropriate format for clearance and settlement of the funds. The appropriate format may be dependent upon the country where the bank account of the second entity 102a-102n for that Detail Record is located. The format should be compatible with the requirements of the bank holding the bank account and the clearing institutions that are used to clear the cash transfer. In a preferred embodiment, the selected format is dependent upon whether the file is for U.S. transactions or international transactions, as described below. It may also be dependent on the Clearing Network 112 being used, as is also described below. The File may be transferred by FTP, for example, preferably along direct telecommunications connections, such as between directly connected routers 107a, 107b. Preferably, the router or routers 107b in the Clearing Network are under the control of the TM 106, as discussed further.

Detail Records for U.S. transactions are preferably converted into a U.S. standard formatted file. Currently, the standard format for U.S. transactions is the National Automated Clearing House Association (“NACHA”) format, which is known in the art. Detail Records for international transactions are converted into an international formatted file. Currently, the standard format for international transactions is the United Nations Electronic Data Exchange Administration, Commerce and Transport format (“UN/EDIFACT”), which is also known in the art. If the Clearing Network is ABN AMRO Bank, Amsterdam Netherlands (“ABN AMRO”), the Detail Records in the Basic Funding File for all transactions are converted into the UN/EDIFACT format for all cash transfers, including transfers of U.S. dollars to a U.S. bank account. The converted Basic Funding Files, formatted for U.S. and for international transactions, are referred to herein as a “Worldwide Funding Files.”

The type and format of information required to settle international transactions may vary from country to country. In the preferred embodiment, the TM 106 further incorporates country specific information into the Worldwide Funding File, which is required for the clearing institutions in a particular country. If ABN AMRO is the Clearing Network 112 for the transfer of U.S. dollars to a U.S. bank account, the UN/EDIFACT format is used and the U.S. country specific information in the NACHA format is added. If the currency is not U.S. dollars and/or the bank account is not in the U.S., the country specific information and format for the country where the bank account is located is added to the Worldwide Funding File. The Worldwide Funding File, with the addition of country specific information, is referred to as a “Country Specific Funding File.” The Country Specific Funding File preferably contains only Detail Records pertaining to cash transfers to bank accounts in a single country. However, Detail Records for cash transfers to bank accounts in different countries may be in the same Country Specific Funding File, as well. If that is the case, Detail Records for cash transfers to the same country may be in subfiles within the Country Specific Funding File. Information required by the Clearing Network 112 may also be added to the File. These and other functions of the TM 106 are described in more detail below.

The TM 106 may be administered by the same party or parties that perform the function of the Platform 104, such as FDMS. The TM 106 may also be administered by another party. The Platform 104 preferably provides the Basic Funding File to the TM 106 in a format requested by the TM 106, to facilitate processing by the TM 106.

The TM 106 provides the Country Specific Funding File to an appropriate Clearing Network 112, 112a . . . 112n, here Clearing Network 112, to clear and settle the transaction or transactions in the Country Specific Funding File. The Clearing Network 112 may comprise a Clearing House 115, which processes the Country Specific Funding File to determine if all requirements for further processing are met, and sends the File to a Clearing Gateway 116. The Clearing Gateway 116 analyzes the Country Specific Funding File to identify an appropriate one of the Network Beneficiary Banks 118a-118n, here Bank 118a, for example, in the same country as the bank account of the entity 102a initiating the transaction, and directs the File to that Bank. The Network Beneficiary Banks 118a-118n are part of or are affiliated with the Clearing Network 112.

Preferably, the Bank 113 includes In Country Accounts 119a, 119b . . . 119n, which are each located in a country where funds may need to be settled. While not required, this is preferred for tax purposes. Cash for settlement is preferably transferred from the Cash Account 114a of the appropriate currency to an In Country Account, here Account 119a, in the appropriate country.

If the second entity 102a has a bank account with the Network Beneficiary Bank 118a, the money necessary to settle the transaction may be transferred from the appropriate In Country Account 119a to that account. If the entity 102a does not have an account with a Network Beneficiary Bank 118a, then the money is transferred from the Network Beneficiary Bank 118a to the Local Beneficiary Banks 124a, 124b, 124c, . . . 120n where the entity 102a has an account, here Bank 120a, in the same country as the Network Beneficiary Bank 118a.

Transfers of Files within the Clearing Network 112 and to the Local Beneficiary Bank may be by FTP, for example. Clearing Networks 112, 112a-112n are provided by ABN AMRO, described above, J. P. Morgan Chase, New York, N.Y., Standard Charter, New York, N.Y., the U.S. Federal Reserve, and foreign government agencies, for example.

In one embodiment of the invention, the TM 106 monitors the progress of the Country Specific Funding File and cash transfer, and generates Status Files that are provided to the Platform 104.

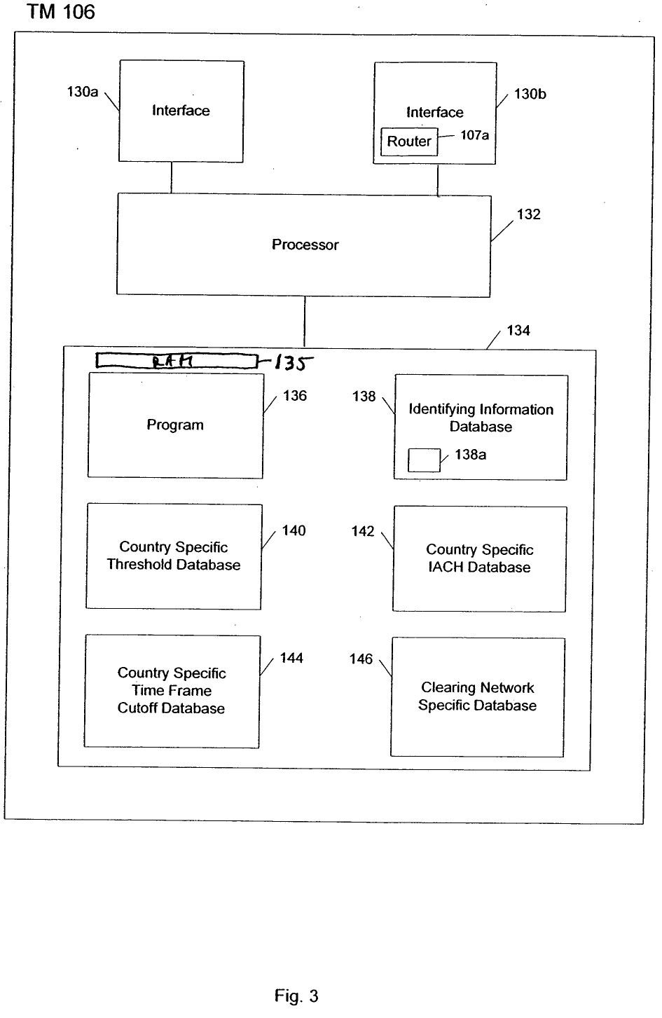

FIG. 3 is a block diagram of the TM 106 in accordance with an embodiment of the invention. The TM 106 may comprise interfaces 130a, 130b, a processor 132 and memory 134. The interface 130a may couple the TM 106 to the Platform 104 via the Internet or an Intranet, for example. The interface 130b preferably couples the TM 106 to the Clearing Network 112 via a direct telecommunications connection. The interface 130b may comprise one or more routers 107a with a direct connection to one or more routers 107b in the Clearing Network 112 (See FIG. 2), for added security. As mentioned above, the router or routers 107b in the Clearing Network are preferably under the control of the TM 106, as well. Files sent to the Clearing Network 112 may therefore be both encrypted and decrypted by the TM 106, prior to transferring the File to the Clearing Network. The TM 106 may also be coupled to the Clearing Network 112 via the Internet or an Intranet, but that is not preferred.

The processor 132 may be one or more central processing units. The memory 134 generically includes disks, caches and volatile and non-volatile memory. For example, the memory 134 may comprise random access memory (RAM) 135 for, among other functions, storage of information and files for processing. The memory 134 may also comprise read only memory (ROM), including a hard drive 136 to store the software program or programs for controlling operation of the TM 106. Other types of data storage devices may be used, as well. The memory 134 may further comprise databases containing information necessary for the creation of the Worldwide Funding File, the Country Specific Funding File and other processing functions of the TM 106. The TM 106 may be an AS/400 server available from IBM Corporation, Armonk, N.Y., for example. Examples of databases are discussed below. Other database arrangements may be used, as well.

In accordance with an embodiment of the invention, the TM 106 has the ability to compare the current information provided by the Platform 104 in the Basic Funding File to information previously provided by the Platform 104 about the second entity 102a-102n. Changes in such information may be indicative of fraud. For example, when a second entity 102a contracts with the Platform 104, the entity typically provides identifying information, such as the entity's name, address, name of bank and bank account number where money is to be transferred to, etc., to the Platform 104. The Platform 104 may in turn provide that information to the TM 106. TM 106 may store this information in an Identifying Information Database 138, for example, associated with an identification number of that entity 102a. When the Platform 104 provides Detail Records of transactions involving the second entity 102a, the identifying information in the Detail Record may be compared to the identifying information in the Identifying Information Database 138, to determine if they are the same. If not, the Platform 104 may be informed of the change. One or more changes, or multiple changes over time, may cause the Detail Record to be rejected due to a suspicion of fraud. In one implementation, a minor change, such as a change in name of the second entity 102a in a Detail Record, will cause the account to be flagged. A report may be generated and sent to the Platform 104, but the Detail Record may not be rejected. Subsequent changes by that second entity 102a may, however, cause rejection of the Detail Record. A Database 138a may be provided to store such changed events with respect to the respective second entity 102a, so that such changes may be monitored. Database 138a may be part of the Identifying Information Database or may be a separate database.

The TM 106 may also determine whether a transaction to transfer cash into a specific country is considered by that country to be high value transaction that needs to be sent by wire transfer or a low value transaction that may be sent by automated clearing house, based on thresholds established by the country where the bank to receive the money is located. For example, in Germany, transactions above 25,000 Euros must be transferred by wire. In the U.S., while there are no formal requirements or regulations, transactions above 1 million dollars are generally conducted by wire. The memory 134 may include a Country Specific Threshold Database 140, which contains the respective monetary value thresholds for particular countries for high and low value transactions. Wire transfer is well known in the art.

Countries may also have different information and formatting requirements for transaction files to be processed and cash transferred through their clearing institutions, such as the Network Beneficiary Banks 118a-118n and Local Beneficiary Banks 120a-120n. Such information and formatting requirements need to be incorporated in the Worldwide Funding File to form the Country Specific Funding File. For example, for transactions involving pounds and/or a second entity 102a in England, the Bankers Automated Clearing Service, Ltd. (“BACS”) format is required. For transactions involving Canadian dollars and/or a bank of a second entity 102b in Canada, the Canadian Payments Association (“CAP”) format is required. Country Specific information may include the length of fields. For example, in one country, a bank account field may be 10 spaces and in another country, the bank account field may be 12 spaces. The Worldwide Funding File in UN/EDIFACT format is modified to conform to the requirements of the country to which the cash is to be transferred.

Other country specific information may include the number of decimal places in a country's currency. For example, when denominating money in Japanese Yen, decimals are not used. When denominating money in U.S. dollars or Euros, two decimal places are used. Some currencies use three decimal places. Even though a currency may use three decimal places, to simplify processing, the TM 106 may limit the number of decimal places to two, which is sufficient for most currencies. Currencies with three decimal places would then be rounded off to two decimal places.

This Country Specific information may be stored in a Country Specific Database 142 in the TM 106. The currency/decimal place correlation may be stored in a currency table in Database 142, for example. A plurality of databases or tables may be provided, each dedicated to a different type of country specific information.

Countries may also have different cut off time frames within which money transfers must be completed on a particular day. If cash transfer is not completed by the cut off time, the money transfer is deferred to the next day. The TM 106 may include a Country Specific Cut Off Time Frame Database 144, which contains the respective cut off time frames for particular countries, as well. In the U.S., individual banks may have their own cut off time frames, which may also be stored in the Database 144 or another such Database.

Countries also have regulations concerning when cash needs to be transferred into an account of a second entity 102a. Countries typically require the cash to be transferred within 4 or 5 business days of the transaction, for example. The date by which cash transfer is required is referred to as a value date. A value date indicator indicative of the number of days may be provided by the Platform 104 in the Basic Funding File. The number of days may be defined in contracts between the Platform 104 and the entity 102a-102n, as well.

The actual payment date may be calculated by the processor 132 of the TM 106, based on the value date, the date of the transaction and country specific rules and practices concerning what counts as a “business day.” For example, banks may be opened in different countries on different days. As discussed above, in Israel, for example, banks are opened on Friday and Sunday, while in Muslim countries, banks may be closed on Friday. In the United States, some banks are opened on the weekends. For banks in the U.S. opened on a Saturday or Sunday, those days may count as business days, at least for transfers with the bank itself The Country Specific and bank specific information may be provided in the Country Specific Database 142 or in another database in the memory 134.

As mentioned above, a plurality of Clearing Networks 112, 112a-112n are available. The TM 106 may select one of the available Clearing Networks 112, 112a-112n to use for particular Detail Records based on the fees charged by the Network, the time required for the Network to settle the transaction underlying the Detail Record, the capabilities of the Network, etc. The capabilities of the Clearing Network 112 include whether the Network can clear and settle funds in the particular country where the second entity 102a-102n has their bank account. Such information may be stored in a Clearing Network Specific Database 146.

The Clearing Network 112 and the Network Beneficiary Banks 118a-118n for the transaction in a particular country may also have information, format and security requirements. For example, file encryption using secure keys may be required. Router codes to convey the file to the financial institution may be required, as well. Such Clearing Network Specific Information may also be stored by the TM 106 in a Clearing Network Specific Database 146 or in a separate database.

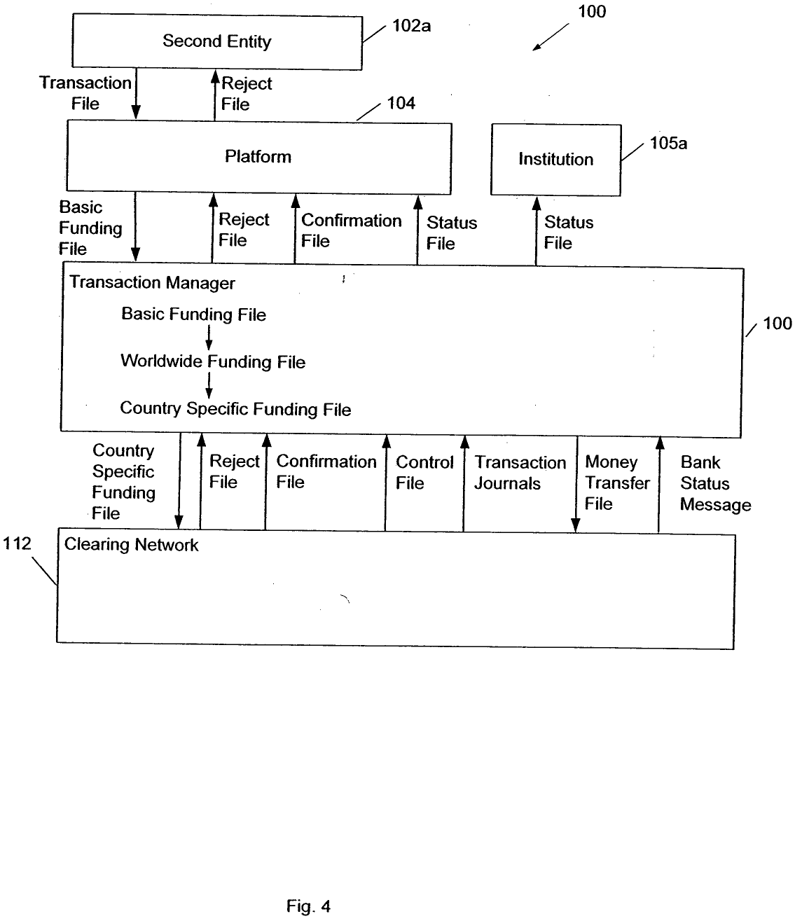

FIG. 4 is a simplified representation of the System 100 of FIG. 1, showing one second entity 102a, the Platform 104, an Institution 105a, the Transaction Manager 106 and the Clearing Network 112, as well as certain of the file transfers and file conversions discussed herein.

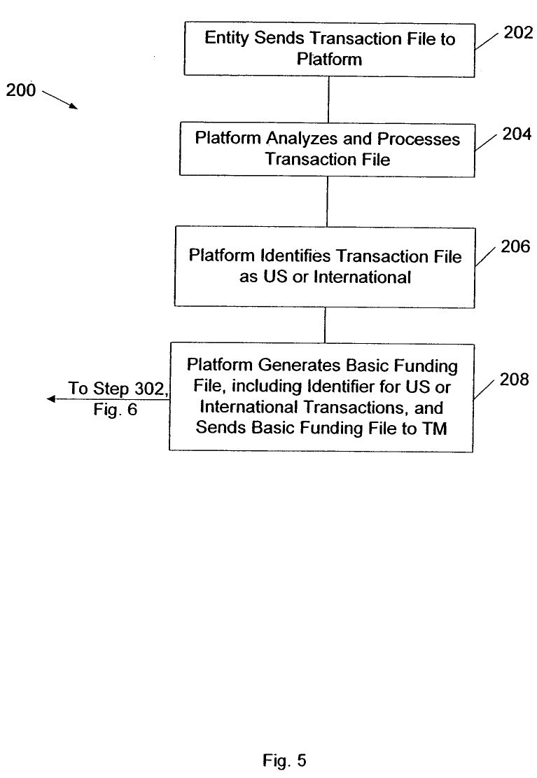

FIG. 5 is an example of a method of operation 200 of the Financial Transaction Clearing System 100 of FIG. 1. One of a plurality of entities 102a-102n, in this example entity 102a, sends a Transaction File containing details related to one or more transactions with respective entities 101a-101n, to be settled. The entity 102a may be a POS merchant, for example, and the Transaction File may contain all the credit card and debit card transactions in the preceding day, for example.

The Platform 104 analyzes and processes the Transaction File, in Step 204. Analysis and processing may include analyzing the Transaction File for transactions with errors, such as incomplete or erroneous data. Errors may be caused by telecommunications error, software error, input error, etc. Transactions with one or more errors may be removed from the Transaction File, or the entire File may be rejected. A Reject File on that transaction may be provided to the respective entity, 102a-102n, who may correct the errors and send the transaction again in a new Transaction File.

The Platform 104 may also identify the transactions of the Transaction File as being a U.S. transaction, in which the currency of the transaction is U.S. dollars and the bank account of the entity 102a is in the U.S., or an international transaction, in which the currency is not U.S. dollars and/or the bank account of the entity 102a is not in the U.S., in Step 206. The Platform 104 generates a Basic Funding File comprising a respective Detail Record corresponding to a transaction, including an identifier to classify the transaction as a U.S. or international transaction. In addition, each Detail Record includes a cash value for the amount of cash to be transferred in each respective transaction. The Basic Funding File preferably includes a total cash value for all the Detail Records. This total may be in a Trailer Record of the File, for example. (The format of the Basic Funding File is discussed further, below.) The Basic Funding File typically includes transactions from a plurality of entities 102a-102n, for a particular time period.

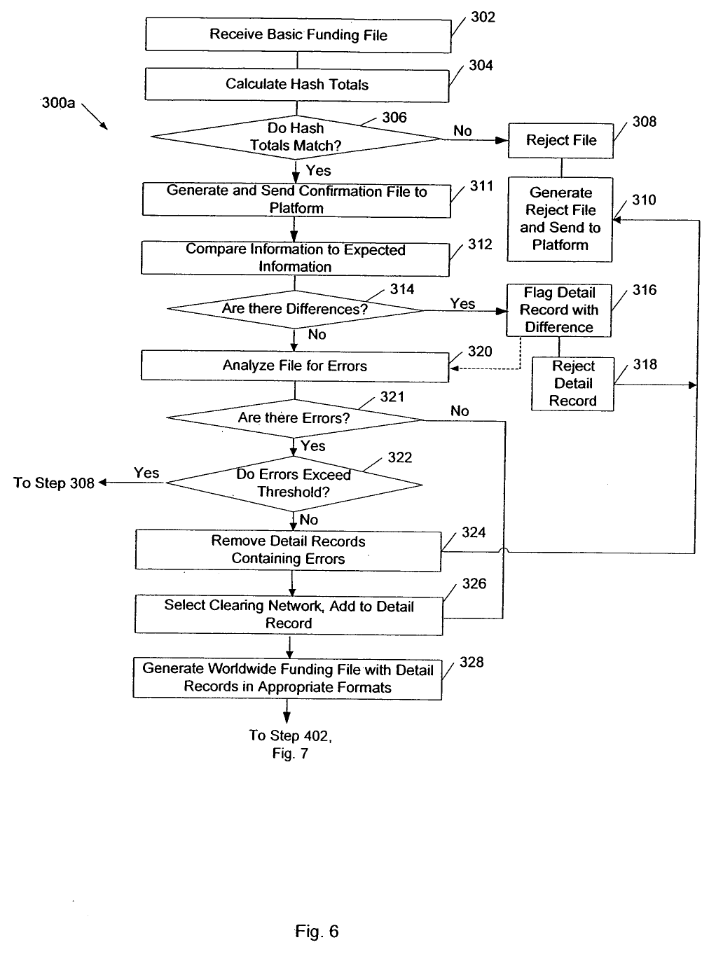

In accordance with an embodiment of the invention, the Basic Funding File is sent to a processor, such as the TM 106, in Step 208. FIG. 6 is an example of a method 300a of managing transactions in accordance with an embodiment of the invention, which may be implemented by the TM 106, for example. The Basic Funding File provided by the Platform 104 in Step 208 is received by the TM 106, in Step 302.

The TM 106 calculates hash totals of the Basic Funding File, in Step 304. Hash totals may be calculated by summing the monetary amounts in each Detail Record in the File and comparing that value to the total cash value for all Detail Records in the File. If the hash totals do not match, the File is rejected in Step 308 and a Reject File is generated and sent to the Platform 104, in Step 310. The Platform 104 may then correct the File and send it back to the TM 106. If the hash totals match, a Confirmation File is generated and sent to the Platform 104, to inform the Platform that the Basic Funding File has been accepted for further processing, in Step 311.

Information in each Detail Record in the Basic Funding File concerning each second entity 102a-102n is then preferably compared to expected information, in Step 312. As discussed above, in accordance with one embodiment of the invention, the TM 106 is preferably programmed to compare information previously provided by the Platform 104 to information in the Detail Records. The processor 132 may compare expected information concerning a respective second entity 102a-102n identified in each Detail Record to information about the respective entity in the Identifying Information Database 138.

If there are differences between the information in the Detail Record about the respective second entity 102a-102n and the expected information, in Step 314, the Detail Record is flagged, in Step 316. The second entity associated with the flagged Detail Record and the change may then be stored by the processor 132 in the Database 138a, for example. The Detail Record may then be rejected in Step 318. The method may then return to Step 310 to generate a Reject File identifying the rejected Detail Record and describing the identified change with respect to that Detail Record and the Reject File is sent to the Platform 104. The Platform 104 may then investigate the changes to determine if the changes were made in pursuit of fraud. As discussed above, the TM 106 may tolerate minor changes, such as a change of name of the second entity, particularly if it is the first time such a change occurred. After flagging the Detail Record and storing the information in the Database 138a, the method 300a may proceed to Step 320, as shown in phantom.

If there are no differences in Step 314, each Detail Record for each transaction in the Basic Funding File is analyzed for data errors, such as incomplete or missing information, improper, incomplete or mistaken codes, improper formatting of information, etc. in Step 320. For example, the processor 132 may check each field in each Detail Record in the Basic Funding File and accumulate a count of errors. Data errors and identity changes in Detail Records in the Basic Funding File that may be identified by the TM 106 may include:

Account Number of Second Entity's Bank is Blank

Account Number exceeds Maximum Number of Characters

Invalid Related Transaction Reference Number (a related transaction is a prior submitted, rejected transaction). Number is already used.

Account Name Entry is Blank

Second Entity's International Bank Code is Blank

Second Entity's Local Branch Code is Blank

Invalid Account Number

Currency Code is Blank

Invalid D-days (D=Days Prior to Payment)

Invalid Currency Code

Invalid Country Code

Invalid Monetary Amount

Monetary Amount is Zero

Entity Name has Changed

Second Entity's Bank Information has Changed

Second Entity's Contact Information has Changed

Second Entity's Branch Code has Invalid Length

Direct Debit not allowed for Country

Second Entity's Direct Debit Contract Number is Blank

Second Entity's Contact Name is Blank

Second Entity's Contact City is Blank

Second Entity's Contact Country Code is Blank

Number of decimal places of the Amount does not match Currency Table

Number of decimal places of the Amount exceeds the TM 106 limit of 2

Bank Information/Setup not available for this Record

It is noted that two bases are provided for rejection related to the decimal places. One rejection occurs if the number of decimal places of the amount does not match the number of decimal places defined in the Currency Table in the Database 142. For example, the Currency Table database indicates that Yen should have no decimal places. If a decimal place is indicated, the Detail Record is rejected. In addition, to simplify processing, no more than two decimal places are preferably used in the TM 106. If more than two decimals places are provided, the processor 132 preferably rounds the value off to two decimal places and continues to process the Detail Record. The processor 132 also preferably informs the Platform 104 so that in the future, the Platform provides no more than two decimal places.

If there are errors, in Step 321, it may still be advantageous to continue to process the Basic Funding File, so that the processing of Detail Records without errors is not delayed. It is therefore preferred to determine whether the number of Detail Records with errors exceed a threshold, in Step 322. If so, the Basic Funding File is rejected, in Step 308. A Reject File is generated and sent to the Platform 104, in Step 310. The Reject File identifies the Detail Record with the error or errors, and identifies the errors. The Platform 104 may correct the errors and send those Detail Records back to the TM 106 in a new Basic Funding File.

If the number of errors is less than the error threshold, the Detail Records containing errors, if any, are removed from the File, in Step 324, and a Reject File is generated and sent to the Platform 104, identifying the rejected Detail Records and the reasons for the rejection, in Step 310. Processing of the Basic Funding File continues in Step 326.

The threshold applied by the TM 106 may be dependent upon the size of the file. For example, large files, greater than about 10 transactions, for example, may have a smaller threshold than smaller files. A large file may have a threshold of 5% while a smaller file may have a threshold of 10%, for example.

In Step 326, a Clearing Network 112, 112a . . . . 112n is selected for clearance and settlement of the money transfer in each Detail Record, and added to the Detail Record. A Clearing Network 112, 112a . . . 112n may be selected by the processor 132 based on the information in the Clearing Network Specific Database 146, or may have been selected by the second entity 102a, as discussed above. The Clearing Network 112

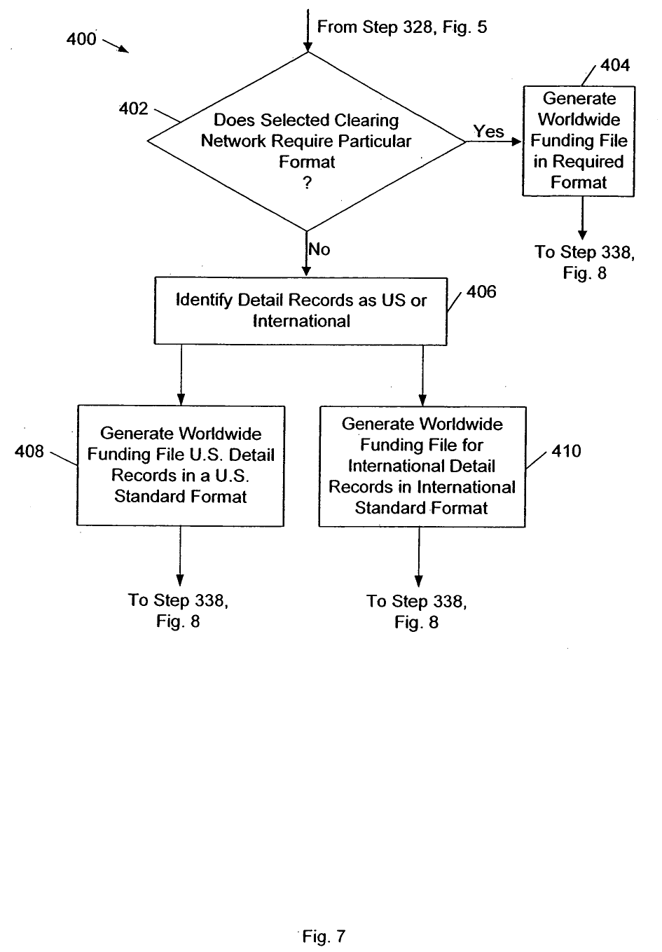

A Worldwide Funding File is generated comprising Detail Records formatted in an appropriate format, in Step 328. Method 400 of FIG. 7 is an example of a method for generating the Worldwide Funding File, in Step 328. It is first determined whether the selected Clearing Network 112 requires that the Detail Records in the Worldwide Funding File be in a particular format, in Step 402. For example, as discussed above, ABN AMRO requires that the File be in UN/EDIFACT format, whether the Detail Record relates to U.S. or international transactions. If so, the Worldwide Funding File is generated with Detail Records in the required format, in Step 404. If not, Detail Records are identified as being for U.S. or international transactions, Step 406.

A Worldwide Funding File of Detail Records of U.S. transactions in a U.S. standard format is generated in Step 408. The U.S. standard format is currently NACHA. A Worldwide Funding File of Detail Records of international transactions in an international standard format, is generated in Step 410. The international standard format is currently UN/EDIFACT. Other formats may be used, as well. The processor 132 is programmed to generate these files.

If the Platform 104 has not identified the Detail Record as being for U.S. or international transactions, the TM 106 may make that determination here. The processor 132 may make this determination based on the Country Code of the second entity's bank, for example, found in the Detail Record.

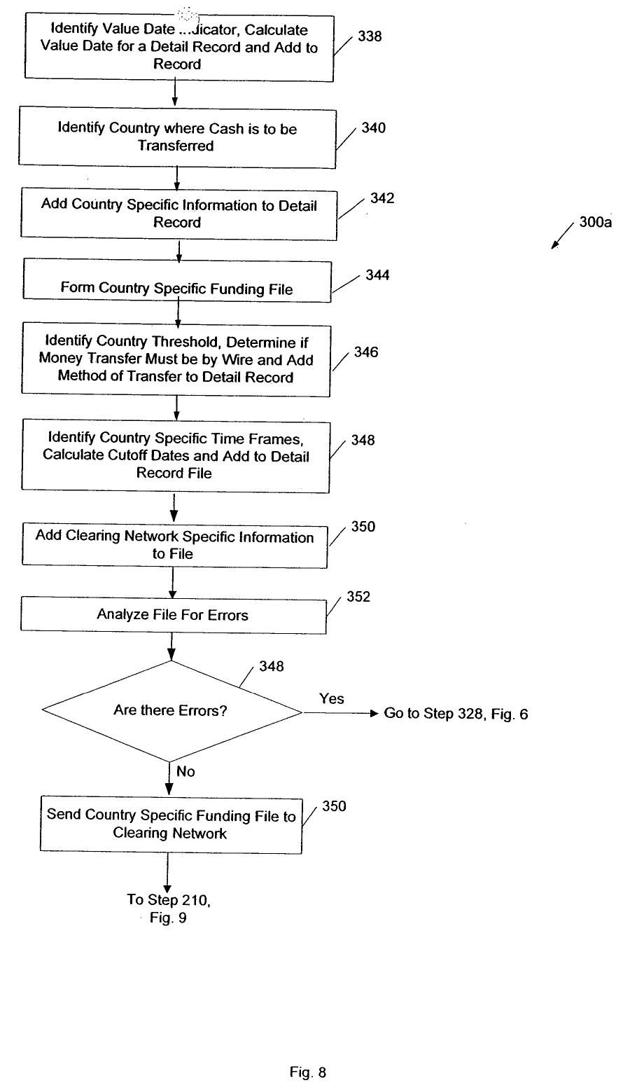

The method 400 returns to Step 338 of the method 300a, from Steps 404, 408 and 410, in FIG. 8, which is a continuation of the method 300a of FIG. 6. In Step 338, the value date indicator for each Detail Record is preferably identified, the value date is calculated, and the value date is added to the Detail Record. The value date indicator may be identified by the processor 132 in each Detail Record. The processor 108 may calculate the value date based on the current date, the value date indicator and other country specific information, such as whether banks in that country are opened on Friday, Saturday or Sunday. Such information may be stored in the Country Specific Database 142 or another such database, as discussed above.

The country where the money is to be transferred to is identified in Step 340, if it has not already been identified. The country may be identified by the processor 132 via a Country Code in the Detail Record for the Worldwide Funding File or Basic Funding File, depending on when this step is conducted.

As discussed above, countries may have different information and formatting requirements for transaction processing and money transfer. The UN/EDIFACT or other such international formatted Detail Records are therefore preferably modified and/or enhanced to include country specific information and country specific formatting requirements, in Step 342. Country specific information and formatting requirements may be found by the processor 132 in the Country Specific Database 142, for example, based on the Country Code. If the UN/EDIFACT format is used for U.S. transactions by ABN AMRO, the country specific information and formatting added to the Detail Record is that of the NACHA format.

Country Specific Funding Files are formed in Step 344. Preferably, Detail Records for cash transfer to particular countries are provided in the same Country Specific Funding File. However, a Country Specific Funding File may include Detail Records related to multiple countries, in which case Detail Records related to the same country would be organized in the same subfile within the Country Specific Funding File.

Country thresholds for cash transfer mode (clearing house or wire transfer) are identified for the country identified in Step 346. The country thresholds for the country of each transaction may be found by the processor 108 in the Country Specific Threshold Database 110a, based on the Country Code for the bank where the bank account of the second entity 102a is located, in the Detail Record. The mode of transferring the cash may then be added to the Detail Record, also in Step 346.

As was also discussed above, countries may establish cut-off time frames within which money transfers must be completed or the transfer deferred until the next day. The Country Specific Cut Off Time Frames are preferably identified, cut off times and dates are calculated and incorporated in the Country Specific Funding File, in Step 348. Country Specific time frames may be found by the processor 108 in the Country Specific Time Frame Cutoff Database 144, based on the Country Code in the Detail Record. For U.S. transactions, cut off time frames for individual banks may also be found in the Database 144, based on the Bank or Bank Branch Code.

Additional Clearing Network Specific Information, such as format and security requirements, is incorporated in the Worldwide Funding File, in Step 350. Such information may also be found by the processor 132 in the Clearing Network Specific Database 146 or other such database in the TM 106, for example.

The Country Specific Funding File is checked for errors, in Step 352. Errors that may be found in this step include processing errors due to reformatting in the NACHA or UN/EDIFACT formats, incorrect transaction amounts, misplacement of a decimal point, missing names of a bank or originating entity, etc. If there are errors, the method returns to Step 328 (FIG. 6) to repeat the processing required to create the Worldwide Funding File and Country Specific Funding File.

If or when there are no errors, the Country Specific Funding File is sent to the selected Clearing Network 112, in Step 350. As discussed above, the File is preferably sent via the interface 130b via a direct telecommunications connection between routers controlled by the TM 106, for security. The File is also preferably encrypted by the TM 106 prior to sending, and is then decrypted by the TM 106 at the Clearing Network 112.

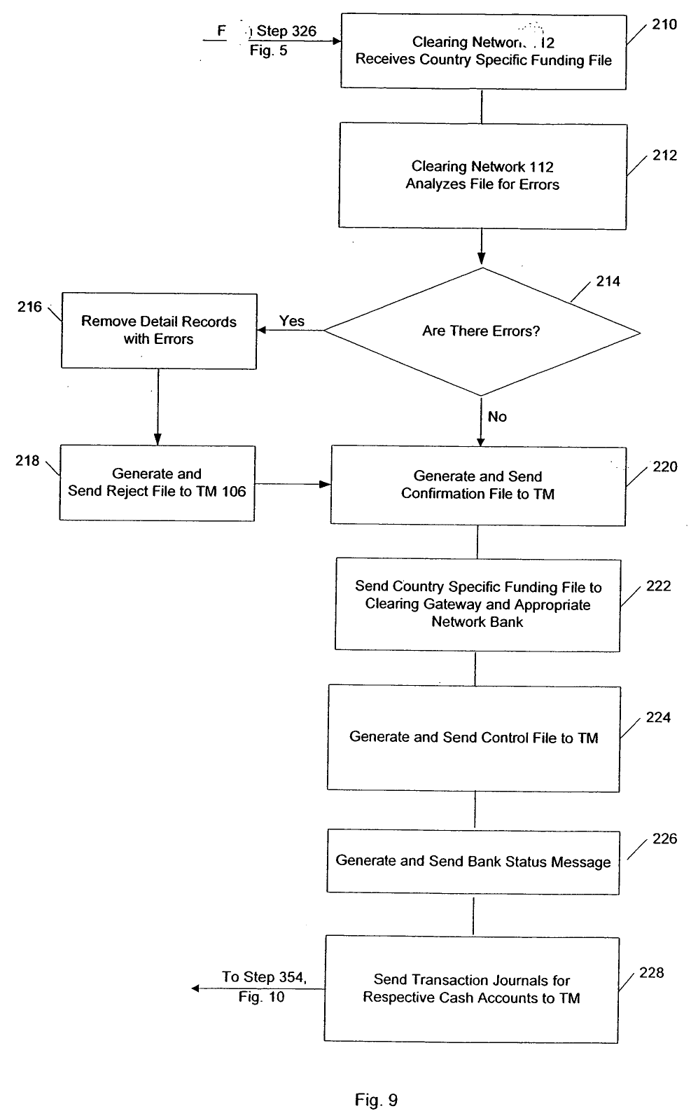

The method of operation 200 of the Financial Transaction Clearing System 100 continues in Step 210 of FIG. 9, where the Country Specific Funding File is received by the Clearing Network 112. The Global Clearing Network 112 checks the Country Specific Funding File for errors, in Step 212. The Clearing House 115 may perform this function, for example.

In one implementation, the following errors may cause rejection of the Country Specific Funding File by the Clearing Network 112:

Second Entity's Account Number Unknown

Network or Local Beneficiary Bank Account Number Unknown

Network or Local Beneficiary Bank not Possible

Currency Code not Possible

Financial Information of Second Entity's Local Beneficiary Bank Incorrect

Charge(s) Detail not Correct

Second Entity's Account Closed

Transaction Rejected Due to Insufficient Funds in Cash Account 114a-114n

Second Entity's Bank Unknown

Invalid Account Number

Bank Branch Number and/or Details Invalid

Totals for Transaction do not match Total of Detail Records

Method of Payment Invalid

The Network Beneficiary Bank 118a-118n may also analyze the Country Specific Funding File for errors in Step 214. The types of errors that may be identified by the Network Beneficiary Bank 118a-118n include withdrawal of authorization by the first or second entities 101a, 102a, and problems with funding or accounts, for example. For example, the following errors may cause rejection of the country Specific Funding File by the Network Bank 118a:

Unknown Error (Process stopped for unknown reason)

Insufficient Funds

Second Entity's Account Closed

No Account/Unable to Locate Account

Invalid Account Number

Returned per Clearing Network's Request

Authorization Revoked by First Entity

Payment Stopped or Stop Payment on Item

Uncollected Funds

Second Entity Advises Transfer not Authorized

Item is Ineligible (Attempt to post unsuccessful)

Bank Account changed without Notice

Signatures not Genuine (in electronic check and electronic fund transfer)

Item Altered (data alteration)

Branch Sold to another Financial Institution

Account Frozen

Non Transaction Account

Credit Entry Refused by Bank

Duplicate Entry

If it is determined that there are errors, in Step 214, the Detail Records with the errors are removed from the Country Specific Funding File, in Step 216 and a Reject File is generated and sent to the TM 106, in Step 218. The Reject File identifies the rejected Detail Records and the error or errors causing the rejection. The TM 106 may correct the errors and send the Detail Records back to the Clearing Network 112 in another Country Specific Funding File.

A Confirmation File is also generated and sent to the TM 106, in Step 220, in either case. The Confirmation File relates the number of accepted and rejected Detail Records from a Country Specific Funding File.

If the Country Specific Funding File is acceptable, the Network Bank 118a generates a Control File and sends the file through the Clearing Network 112, to the TM 106, in Step 224. The Control File summarizes the total cash value of all the money transfers in the File and the number of Detail Records in the File.

The Country Specific Funding File is sent to the Clearing Gateway 116 and an appropriate Network Bank 118a, for example, based on the country to which the money is to be moved, in Step 222. A bank status. message, such as a BANSTA, is preferably generated and sent to the TM 106 by the Clearing Network 112, indicating that the file has been received by the appropriate Network Bank 118a, in Step 226. A BANSTA is a message sent among financial institutions to provide status information about execution of instructions, for example, and is known in the art. A positive Bank Status Message indicates that the Country Specific Funding File has been successfully transferred and is accepted. A negative Bank Status Message indicates that the File is not accepted and why.

The Clearing Network 112 generates a Transaction Journal including an account balance, such as a financial statement of an account (“FINSTA”), for each Cash Account 114a-114n dedicated to funding transactions, in Step 224. As mentioned above, separate accounts may be provided for each currency from which money is required to settle a transaction. The FINSTA shows the debits, credits and current balance of the account. FINSTA statements are also known in the art. The FINSTA or other such transaction journal is preferably generated periodically. It may be generated five times per day, for example.

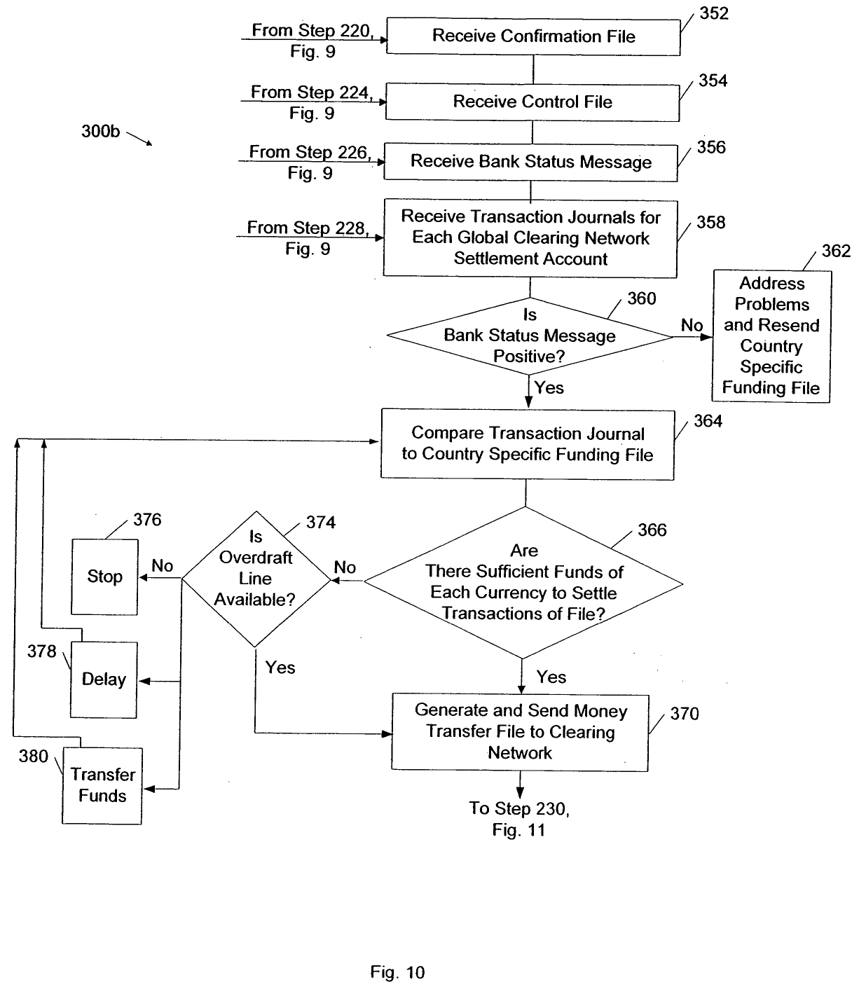

Returning to the operation of the TM 106, in FIG. 10, method 300b is an example of another embodiment of the invention. The Confirmation File is received in Step 352, the Control File is received in Step 354, the Bank Status Message is received in Step 356 and the Transaction Journal is received in Step 354. If any of these files are not received, the method does not continue and the TM 106 may contact the Clearing Network to inquire why.

If all the files have been received but the Bank Status Message is not positive, in Step 360, the TM 106 may address problems in the Country Specific Funding File and send it to the Clearing Network again in Step 362. If the Bank Status Message is positive, the processor 132 of the TM 106 compares the Transaction Journals to the Country Specific Funding File, in Step 364, to determine whether there are sufficient funds to settle the transactions in the File, in each currency, in Step 366. If there are sufficient funds in Step 366, the processor 132 generates and sends a Money Transfer File to cause an appropriate amount of cash to be moved from an appropriate one of the Cash Accounts 114a-114n to an appropriate one of the In Country Accounts 119a-119n, in Step 370. The cash is typically moved by wire transfer from the Cash Account 114a-114n to the In Country Account 119a-119n. The File may be sent to the Clearing Network 112 via FTP, for example.

If it is determined that there are not sufficient funds of a particular currency in a Cash Account 114a-114n for that currency, in Step 366, the TM 106 may determine whether an overdraft line of credit may be relied upon, in Step 374. If the overdraft line of credit is available, settlement is authorized, in Step 370, by generation of the Money Transfer File, as discussed above.

If an overdraft line of credit is not available, settlement is not authorized and the process is stopped with respect to this Country Specific Funding File, in Step 376. Alternatively, TM 106 may instruct the Clearing Network 112 to delay settlement for a period of time, such as 24 hours, for example, in which time additional funds may become available in the settlement account. Step 364 is returned to after the period of time, to again determine if sufficient funds are available, in Step 378. The TM 106 may also order the transfer of funds of the appropriate currency to the respective Cash Account 114a-114n from an appropriate Payment Source 108, for example, in Step 380. Step 364 may then be returned to at an appropriate time to again determine if there are sufficient funds.

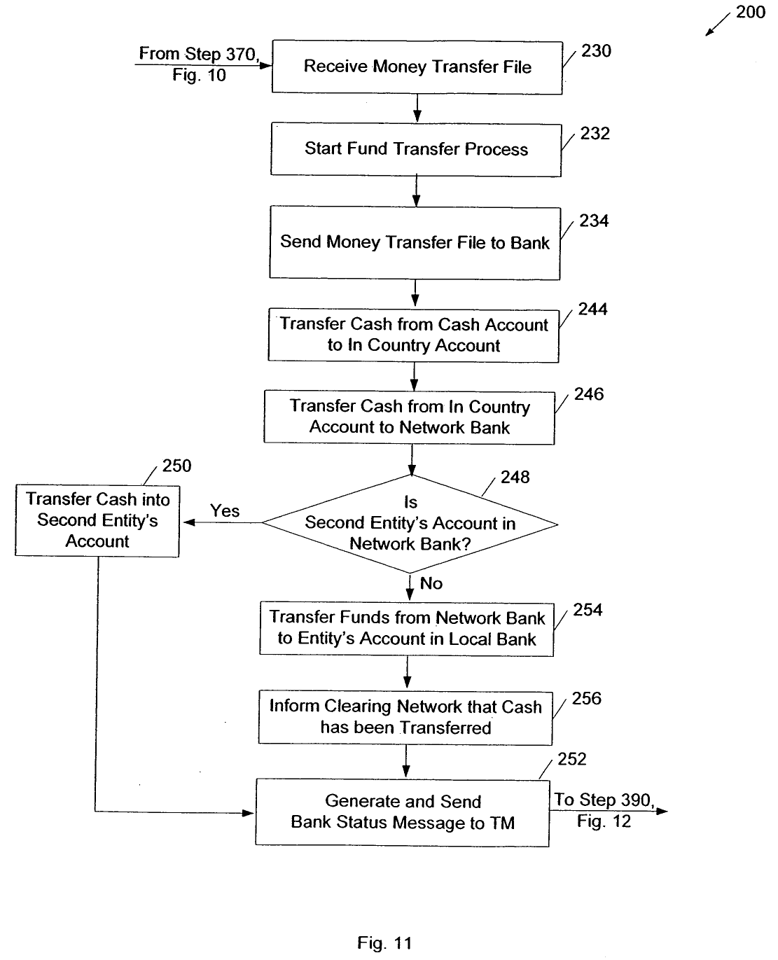

The method 200 continues in FIG. 11, where the Money Transfer File is received by the Clearing Network 112, in Step 230. In response, the Clearing Network 112 starts the transfer process, in Step 232. The Clearing Network 112 conveys the Money Transfer File to the Bank 113, to cause transfer of cash from an appropriate Cash Account 114a-114n to an appropriate In Country Account 119a-119n in Step 234, as discussed above.

The total amount of cash identified in the Money Transfer File in the proper currency is transferred from an appropriate one of the Cash Accounts 114a-114n, in this example Account 114a, or the Payment Source 108, to an appropriate one of the In Country Accounts 119a-119n, here Account 119a, in a manner known in the art, in Step 244. The money may be transferred by wire transfer, for example, which is known in the art.

The cash is then transferred to the appropriate one of the Network Banks 118a-118n, here 118a, in Step 246. The cash may be transferred by low value clearing or by wire transfer, as determined by the TM 106 based on country thresholds, as discussed above.

If the second entity's bank account is found to be with the Network Bank 118a, in Step 248, the cash is put into that account, in Step 250. After a cash payment is made or while the cash is awaiting posting to the second entity's cash, a bank status message, such as a BANTSA, is generated and sent to the TM 106, in Step 252. The BANTSA may be provided from the Network Beneficiary Bank 118a to the TM 106, via the Clearing Network 112.

If the second entity 102a does not have an account with the Network Beneficiary Bank 118a, the Network Beneficiary Bank will send the Settlement File to the Local Beneficiary Bank 120a-120n where the entity has an account, here, Local Beneficiary Bank 120a, as is known in the art. The transfer may take place by low value clearing or by wire transfer, as determined by the TM 106 based on the country threshold. The Local Beneficiary Bank 120a may also check the Cash Payment File for errors. If the File is acceptable, funds are transferred from the Network Beneficiary Bank 118a to the second entity's account at the Local Beneficiary Bank 120a.

The Local Beneficiary Bank 120a will inform the Clearing Network 112 whether the cash has been successfully transferred or not, in Step 256. The Clearing Network 112 will generate and send the Bank Status Message to the TM 106, in Step 252, as described above.

Preferably, in accordance with another embodiment of the invention, the TM 106 generates a Status File for each Detail Record provided to the Clearing Network 112, based on the Confirmation File, Control File, Transaction Journal and Bank Status Message received from the Clearing Network 112, after the cash has been transferred to the bank account of the second entity 102a, or an attempt to transfer the money has been made. The Transaction Journal indicates whether the transfer has been successful or not. The Status File is a detailed flow summary of the steps in the clearance and settlement process and the times the events took place. The Status File is provided to the Platform 104 and preferably to the appropriate Institution 105a-105n associated with that Detail Record, as well. The Platform 104 may then inform a respective second entity 102a-102n whether the money has been transferred or not The Status File preferably contains the necessary information to describe an event related to the processing of the Country Specific Funding File by the TM 106 and the Clearing Network 112a, to the Platform 104. The events that may be reported include, for example, acceptance or rejection of the Country Specific Funding File by a Network Beneficiary Bank 118a-118n, payment to the second entity's account in the Network or Local Beneficiary Bank 118a-118n, 120a-120n, an unsuccessful attempt to pay the Network or Local Beneficiary Bank 118a-118n, 120a-120n and return of the Country Specific Funding File to the TM 106 due to errors. The Status Files may be organized by date, Platform 104 and Institution 105a-105n.

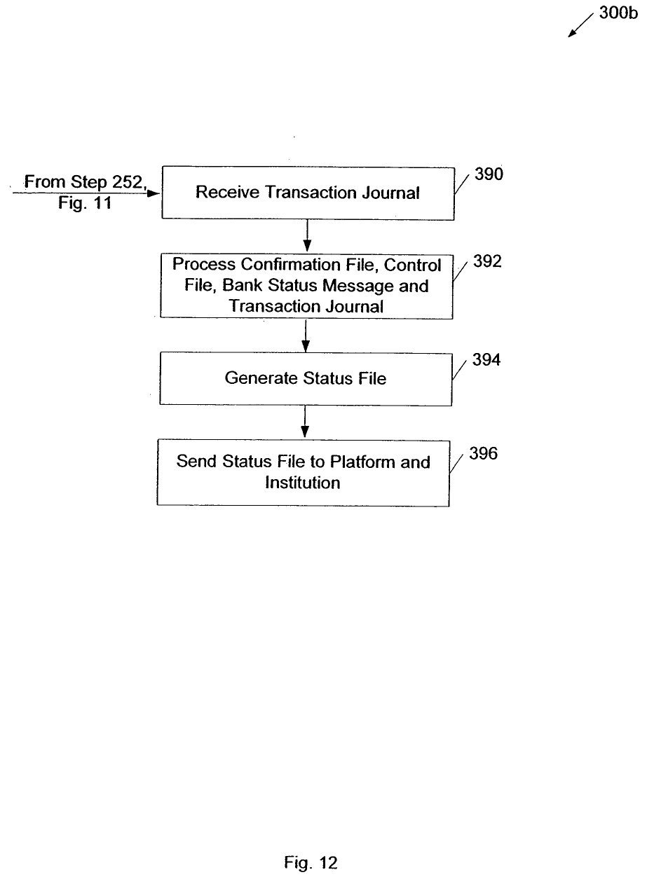

FIG. 12 continues the example of the method 300b in accordance with this embodiment of the invention. The Transaction Journal is received by the TM 106, in Step 390. The Confirmation File, Control File, Bank Status Message and Transaction Journal are processed, in Step 392. A Status File is generated, in Step 384, and sent to the Platform 104 and appropriate Institution 105a-105n, in Step 396. The File may be sent via FTP, for example. The Status File may be generated by the processor 132.

The respective second entity 102a-102n may then post the payment to their accounts receivable. The Platform 104 may also create an accounts receivable and offset the amount of the transferred money on the entity's general ledger. Previously, payments have assumed or second entities 102a-102n have had to monitor their accounts.

The TM 106 preferably gives access to Institutions 105a-105n to information about the status of the progress of particular Detail Records that they are associated with. The Detail Records may have an identification of the respective one of the Institutions 105a-105n, here 105a, associated with the underlying transaction. The Institution 105a only has access to the information about the Detail Records that include an identifier of that Institution. The Institution 105a may thereby obtain current information about the status of the processing of those Detail Records, including identification of rejected Detail Records and the reason for the rejection, and the progress of the associated cash transfer through the Clearing Network 112, based on the information and files provided by the Clearing Network 112 to the TM 106.

The status related information may be in the program software itself, in memory 136. The Institution 105a may access the information in the program on the TM 106 via emulation software, such as 5250 emulation software, which is commercially available. The Institution 105a may view accessed information on a PC in its own facility, for example. The Institution 105a may have a user identification and a password, for security.

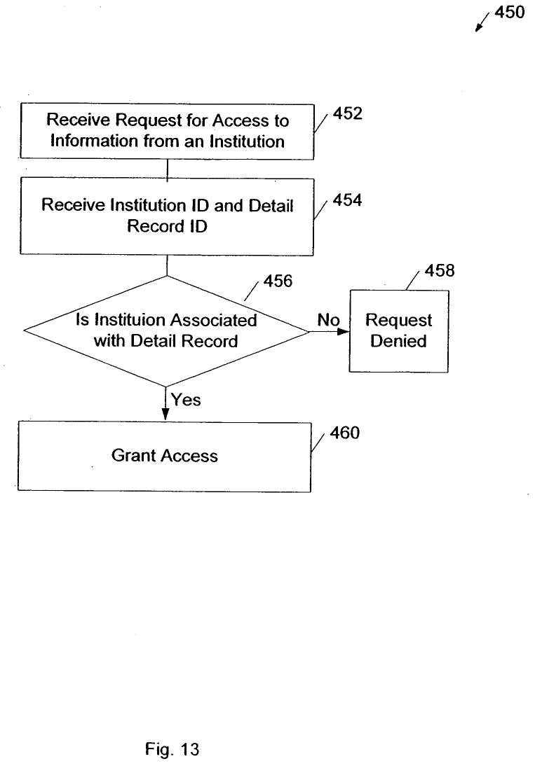

FIG. 13 is an example of a method 450 for the TM 106 to grant access to information to an Institution 105a-105n, in accordance with another embodiment of the invention. A request for access is received from an Institution, here Institution 105a, including a proper user name and password, in Step 452. An Institution Identification (“ID”) and a Detail Record Identification (“ID”) are received, in Step 454. (The Institution ID may have been received with the initial request during sign in Step 452.). The Institution ID and the Detail Record corresponding to the Detail Record ID are compared to determine whether the Institution is associated with that Detail Record, in Step 456. The Detail Record may include the Institution ID of its associated Institution, for example, which may be checked by the processor 132. If it is determined that the Institution 105a is not associated with the requested Detail Record in Step 458, the request for access is denied in Step 458. If the Institution 105a is found to be associated with the requested Detail Record, access is granted, in Step 460. The Institution 105a can then view the current information about the Detail Record on a PC at its own facility, for example.

Examples of fields that may be provided in certain of the files discussed above, will now be described in more detail. The files preferably comprise a File Header Record, File Detail Records and a File Trailer Record.

The File Header Record of the Basic Funding File may contain the fields identified below in Table I, for example:

TABLE I
FILE HEADER RECORD

| Field | Description |
|---|---|
| Record ID | Constant ‘FH’ |
| Sender ID | Name of the Platform 104 providing File |
| Receiver ID | Name of TM 106 receiving File |
| File Create Date | Date File created by Platform 104 |
| File Create Time | Time File created by Platform 104 |
| File Sequence Number | A unique number assigned by the Platform 106 to |
| | each Transaction File. Numbering may start at |
| | 00001, each day. |
| Institution ID | Name of Owner of relationship with and liable |
| | to second entity in transaction. |

The File Sequence Number may be used, in conjunction with the File Create Date, to uniquely identify each Basic Funding File and to identify duplicate transmissions.

In this example, each Detail Record of the Basic Funding File relates to a single money transfer transaction. Each Detail Record comprises a Record ID (“FD”) to uniquely identify the Detail Record. The Record also comprises an Entity ID Number to identify the second entity 102a-102n to the transaction of that Detail Record, a Trade Name of the second entity, Account and Address details of the second entity, a Monetary Amount of the transaction, a Country Code of the country where the second entity's bank account is located based on International Standard Organization (“ISO”) 3166 and a Currency Code of the currency of the transaction. A Transaction (“TXN”) Reference Number is generated by the Platform 104 to identify each transaction in the Transaction File provided to the Platform 104 by the second entities 102a-102n. These and other fields are described in Table II, below:

TABLE II
DETAIL RECORD FILE

| Fields | Description |
|---|---|
| Record ID | Constant ‘FD’ - file detail |
| Transaction Reference | Generated by the Processor 104 to uniquely identify each |
| Number | transaction in a Transaction File. |
| Transaction Type | ‘01’ - Credit Second Entity's Account |
| | ‘02’ - Debit First Entity's Account |
| Payment Method | “SWT” when pay method must be a wire transfer |
| Currency Code | Currency Code must conform to ISO 4217 |
| Monetary Amount | Transaction (“TXN”) amount |
| Number of Decimal Places | Number of Decimal Places of the Monetary Amount Field, |
| | above. |
| Entity ID | Identification Number of the Second Entity associated with the |
| | TXN, assigned by Platform 104. |
| Entity Name | Trade Name of the Second Entity associated with the TXN. |
| D Days | Represented as NN, where NN is the number of days |
| | (Notational use only - used to notify the customer service |
| | personnel that a longer period of time than the default value |
| | for the Institution was agreed with the second entity). |
| Related TXN Reference | If current Detail Record replaces a rejected Record, this field |
| Number | contains the TXN Number of the rejected TXN. |
| DIRDEB Contract Number | Used when the value in the Transaction Type field is ‘02’. |
| Entity Account Name | Account Holder Name (Second Entity if Credit, First Entity if |
| | Debit payment) |
| Entity's Account Number | Account ID (Second Entity if Credit, First Entity if Debit |
| | payment) |
| International Bank Code | Swift Code of the Second Entity's Bank for wire transfer |
| Entity Local Bank Code | Local Bank Branch Number |
| Bank Name | Name of the Second Entity's Bank |
| Entity City Name | Name of the city where the Receiver is Located |
| Receiver's Country Code | Country Code where the Bank is located. Conforms to ISO |
| | 3166. |
| Contact Name | Contact Name of Second Entity's Account |
| Contact Address 1 | Street and number/P.O. box |
| Contact Address 2 | Continuation of Contact Address 1, if necessary |
| City Name | Contact's City Name |
| Country Sub-Entity ID | Province or State code, or other ID of the area where the |
| | contact resides, if desired |
| Postal Code | Postal code of the contact, if desired |
| | Optional |
| Country Code | Country Code of Contact, conforms to ISO 3166 |

In this example, the File Trailer Record of the Basic Funding File may comprise a Record ID (“FT”) to identify the File Trailer Record. The File Trailer Record may also comprise a Transaction Total, which is the total number of Detail Records in the file, and an Amount Hash Total, which is the total of all the money transfers in the file. This total may be used to check high totals, as described above.

The File Header Record of the Status File may comprise a Record ID of the File, a Sender ID, a Receiver ID, a File Create Date and Time, a Sequence Number and an Institution ID, which have been discussed above. The File Trailer Record may comprise a Record ID and a Record Total identifying the number of Detail Records in the Status File.

Each Detail Record may comprise the following fields, for example:

TABLE III
STATUS FILE DETAIL RECORD

| Field Name | Description |
|---|---|
| Record ID | Constant ‘FD’ - file detail |
| Second Entity ID | Identification Number of second entity associated with the |
| | TXN of the respective Detail Record |
| Division ID | Division of second entity, if Applicable |
| Transaction Date | ISO date format YYYY-MM-DD |
| Transaction Type | Credit Card, Debit Card, etc. |
| Platform Reference Number | Assigned by Platform 106 to Detail Record in Basic |
| | Funding File |
| Event Code | For Transaction Type, above |
| Sequence Number | A unique number assigned by TM 106 to each Status File. |
| | Numbering may start at 01, each day. |
| Event Date | ISO Date |
| Event Time | ISO time format: HH.MM.SS |
| Message Code | For Rejects, Returns and Notification of Change |
| Message Description | Text |
| Original Transaction Amount | Amount characteristics: |
| | Length of 18, implied decimal mark, zero filled |
| | e.g. 5 dollars having 2 decimal places is depicted |
| | as ‘000000000000000500’ |
| | (the number of decimal positions should be indicated in the |
| | Decimal Places Field, below. |
| Decimal Places - Original | ‘2’ if there are 2 decimal places on original Transaction |
| Transaction Amount | Amount Field |
| Returned Amount | Amount characteristics: |
| | Field Length of 18, implied decimal mark, zero filled |
| | e.g. 5 dollars having 2 decimal places is depicted |
| | as ‘000000000000000500’ |
| | (the number of decimal positions may be indicated in the |
| | Decimal Places field) |
| Decimal Places - Returned | ‘2’ if there are 2 decimal places on Returned Amount |
| Amount | |
| Currency Code | Code for currency transaction |
| Sort Priority | Sorting order of the particular event, which is the Entity's |
| | preferred order of reporting |
| Source Name | BANSTA (Banking Status Message File), or FINSTA |
| | (Financial Statement Message File) |
| Message Severity | Indicative of severity of problem (if there is a problem) |
| Process Name | Event from Front End, Clearing House or Network Bank |
| “Type” indicator | To distinguish positive, negative and warning status records |
| | Values: P = Positive, N = Negative, W = Warning |
| Free Text 1 | if banking system can supply more information about the |
| | rejected item or this can be ‘anything’ to describe the event |
| | further |
| | May also be populated with the Bank Segment or the |
| | Bank Channel/System used for the transaction |
| | If it is a Front End TM Error, this may contain the |
| | erroneous data that the error message is referring to |
| Free Text 2 | Any additional information |
| Free Text 3 | Any additional information |
| Free Text 4 | Any additional information |

As discussed above, the Basic Funding File may be used to both credit an account of a Second Entity 102a, for example, as well as to debit an account of a First Entity 101a, for example. The Transaction Type field in the Detail Record (Table II, above), is used to indicate whether the transaction is a credit or debit transaction. If it is a debit transaction of the First Entity 101a, a corresponding Basic Funding File defining the credit to the Second Entity 102a.

Table IV, below, is an example of a schedule of file delivery dates for selected European countries, where the Clearing Network is ABN AMRO. “D” refers to the payment date. D-1, D-2, D-3 are one, two and three days prior to the payment date, respectively. The first column indicates the number of days prior to payment that a file must be delivered to the Clearing Network. The second column indicates the number of days prior to payment that the TM 106 may provide the Country Specific Funding File to the Clearing Network 112. The third column indicates when the file needs to be delivered to the Clearing Gateway 115 of the Network 112 in order for payment to be rendered on the proper day D, indicated in the fourth column. It is noted that in many countries, such as in Austria and Belgium, the TM 106 may provide the Country Specific Funding File one day earlier than is required. In some countries, such as Denmark and Finland, the TM 106 may provide the Country Specific Funding File two days earlier than is required. The ability to provide the Country Specific Funding File to the Clearing Network 112 one day early may enable faster payment.

TABLE IV

| | Required File | Actual File | File | Beneficiary |
|---|---|---|---|---|
| | Delivery to | Delivery to | Delivered to | Bank |
| Euro | Clearing | Clearing | Clearing | Expected |
| Country | Network 112 | Network 112 | Gateway 116 | Payment |
| Austria | D-2 | D-3 | D-1 | D |
| Belgium | D-2 | D-3 | D-1 | D |
| Denmark | D-1 | D-3 | D | D |
| Finland | D-1 | D-3 | D | D |
| France | D-1 | D-3 | D | D |
| Germany | D-2 | D-3 | D-1 | D |
| Ireland | D-2 | D-3 | D-1 | D |
| Italy | D-2 | D-3 | D-1 | D |
| Netherlands | D-2 | D-3 | D-1 | D |
| Norway | D-1 | D-3 | D | D |
| Portugal | D-2 | D-3 | D-1 | D |
| Spain | D-1 | D-3 | D | D |
| Sweden | D-1 | D-3 | D | D |
| Switzerland | D-2 | D-3 | D-1 | D |
| United | D-3 | D-3 | D-2 | D |
| Kingdom | | | | |

While the discussion above primarily deals with credit card transactions, it will be apparent to one of ordinary skill in the art that the methods and systems of the present invention may be readily applied to other types of financial transactions and cash transfers, such as a debit card transaction, a check payment, an electronic check payment, an electronic funds transfer, a wire payment, etc. For example, in a debit card transaction, where cash is credited to the second entity's account from a bank account of the first entity 101a, for example, identification of the transaction as a debit card transaction and inclusion of information related to the first entity's bank account may be provided in the Basic Funding File and in the Country Specific Funding File.

The systems disclosed herein are in a form in which various functions are preformed by discrete functional blocks. However, any one or more of these functions could equally well be embodied in an arrangement in which the functions of any one or more of those blocks or indeed, all of the functions thereof, are realized, for example, by one or more appropriately programmed processors.

The foregoing merely illustrates the principles of the invention. It will thus be appreciated that those skilled in the art will be able to devise numerous other arrangements which embody the principles of the invention and thus within the spirit and scope of the invention, which is defined in the claims, below.

What is claimed is:

1. A method of managing a cash transfer by or on behalf of a first entity to an account of a second entity, the method comprising:
receiving information related to the cash transfer; and
formatting the information into one of a plurality of formats based, at least in part, on a location of the account.

2. The method of claim 1, wherein the account is a bank account, the method comprising:
formatting the information into one of a plurality of formats based, at least in part, on a location of the bank account.

3. The method of claim 1, comprising:
formatting the information in an National Automatic Clearing House Association (NACHA) format, if the account is in the United States.

4. The method of claim I, comprising:
formatting the information in a United Nations Electronic Data Exchange Administration, Commerce and Transport (UN/EDIFACT) format, if the account is not in the United States.

5. The method of claim 4, further comprising:
adding country specific information related to the country in which the account is located, to the UN/EDIFACT formatted information.

6. The method of claim 5, wherein the country specific information is NACHA format related information, the method comprising:
adding NACHA format related information to the UN/EDIFACT formatted information, if the account is in the United States.

7. The method of claim 1, further comprising:
identifying the country where the account is located;
formatting the information based, at least in part, on the country; and
adding information required by the country to transfer cash into the account, to the formatted information.

8. The method of claim 7, wherein the country specific information comprises formatting information.

9. The method of claim 1, further comprising:
identifying the country where the account is located;
formatting the information based, at least in part, on the country;
determining a time in the country beyond which cash transfer cannot take place; and
adding the time to the formatted information.

10. The method of claim 1, further comprising:
identifying the country where the account is located;
formatting the information based, at least in part, on the country;
determining a value date for money transfer in that country, by which date money must be transferred into the account; and
adding the value date to the formatted information.

11. The method of claim 1, further comprising:
identifying the country where the account is located;
formatting the information based, at least in part, on the country;
determining a threshold for a monetary value above which a cash transfer must take place by wire transfer;
determining whether the cash transfer must be by wire transfer, based on the threshold; and
adding an indication of an acceptable transfer mode to the formatted information based, at least in part, on the threshold.

12. The method of claim 1, further comprising:
selecting one of a plurality of clearing networks to clear and settle the cash transfer; and
adding the selected clearing network to the formatted information.

13 The method of claim 12, comprising:
selecting the clearing network based on a comparison of at least one of fees, time to settlement and capabilities of the clearing networks.

14. The method of claim 1, wherein information about the second entity is stored in memory and the received information about the cash transfer comprises information about the second entity, the method further comprising:
comparing the received information about the second entity to the stored information.

15. The method of claim 14, further comprising:
ceasing processing of the cash transfer if there is a difference between the received information and the stored information.

16. The method of claim 14, comprising:
receiving the information related to the cash transfer from a party; and
informing the party of the difference between the received information and the stored information.

17. The method of claim 1, wherein the information relates to a plurality of cash transfers, and the information is provided in a file comprising a respective record for each cash transfer and a total amount of the cash transfers in all the records, the method comprising:
receiving the file;
summing the amounts of the cash transfers in each record;
comparing the summed cash value to the total value; and
rejecting the file if the summed value and the total value are different.

18. The method of claim 17, wherein the file is provided by a party, the method further comprising:
reporting the rejected file to the party.

19. The method of claim 1, further comprising:
analyzing the information for data errors.

20. The method of claim 19, wherein the information relates to a plurality of cash transfers, each described in a respective record in a file, the method further comprising:
summing the number of records with an error;
comparing the sum to a threshold; and
rejecting the file if the number of records with errors exceed the threshold.

21. The method of claim 20, wherein the file is provided by a party, the method further comprising:
informing the party of an identity of the records with errors.

22. The method of claim 20, wherein the file is provided by a party, the method comprising:
summing the number of records with an error;
comparing the sum to a threshold; and
if the number of records with errors is less than the threshold, removing the records with errors from the file.

23. The method of claim 22, wherein the file is provided by a party, the method further comprising:
informing the party of an identity of the records with errors.

24. The method of claim 1, further comprising:
sending the formatted information to a clearing network to clear and settle the cash transfer.

25. The method of claim 1, further comprising:
receiving information from the clearing network concerning a status of the clearance and settlement of the cash transfer; and
informing a party of the status.

26. The method of claim 1, comprising:
receiving the information from a platform chosen for the group consisting of a credit card processor, a bank, a business-to-business gateway for electronic fund transfer, a business-to-consumer gateway for electronic fund transfer or a consumer-to-business gateway for electronic fund transfer.

27. The method of claim 1, wherein the cash transfer relates to a transaction between the first and second entities, the method comprising:
receiving information related to a transaction chosen from the group consisting of a credit card transaction, a debit card transaction, a payment by check, an electronic funds transfer and a wire payment between the first and second entities.

28. The method of claim 27, comprising:
receiving information chosen from the group consisting of the first entity, the second entity, a cash value of the transaction, a date of the transaction, a time of the transaction, a currency of the transaction, a bank of the second entity, and a bank account of the second entity.

29. The method of claim 1, comprising:
formatting the information based, at least in part, on a clearing network to be used to transfer the money.

30. The method of claim 1, comprising:
formatting the information into a first format if the bank account is in the United States; and
formatting the information into a second format if the bank account is not in the United States.

31. A method of managing cash transfers by or on behalf of at least one first entity to a bank account of at least one respective second entity, the method comprising:
receiving information related to the cash transfer in the form of a file comprising at least one record related to a respective cash transfer, from a party;
formatting the information in the at least one record into one of a plurality of formats based, at least in part, on a country where the bank account of the second entity related to the cash transfer of the record is located, to form a formatted record; and
sending a file comprising at least one formatted record to a clearing network.

32. The method of claim 31, further comprising:
identifying the country where the bank account is located, for a formatted record;
retrieving country specific information required by the country in order to transfer cash into the bank account, from memory; and
adding the country specific information to the formatted record.

33. The method of claim 32, further comprising:
retrieving country specific formatting information required by the country in order to transfer cash into the bank account, from memory; and
modifying a formatted record to meet formatting requirements of the country.

34. The method of claim 33, further comprising:
retrieving a time in the country beyond which cash transfer cannot take place, from memory; and
adding the time to the formatted record.

35. The method of claim 34, further comprising:
retrieving a value date for money transfer in the country, by which date money must be transferred into the account, from memory; and
adding the value date to the formatted record.

36. The method of claim 35, further comprising:
retrieving a threshold in the country for a monetary value above which a cash transfer must take place by wire transfer, from memory;
determining whether the cash transfer of the formatted record must be by wire transfer, based on the threshold; and
adding an indication of an acceptable transfer mode to the formatted information, based, at least in part, on the determination.

37. The method of claim 31, further comprising:
selecting one of a plurality of available clearing networks to clear and settle the cash transfer of formatted record; and
adding the selected clearing network to the formatted record.

38. The method of claim 37, comprising:
selecting the clearing network based on a comparison of at least one of fees, time to settlement and capabilities of available clearing networks.

39. The method of claim 31, comprising:
formatting the information based, at least in part, on a clearing network to be used to transfer the money.

40. The method of claim 31, comprising:
formatting the information into a first format if the bank account is in the United States; and
formatting the information into a second format if the bank account is not in the United States.

41. A method of managing cash transfers by or on behalf of at least one first entity to a bank account of at least one respective second entity, the method comprising:
receiving information about a second entity, from a party;
storing the received information about the second entity;
receiving information related to the cash transfer in the form of a file comprising at least one record related to a respective cash transfer, from the party; and
comparing the received information about the second entity to the stored information.

42. The method of claim 41, further comprising:
ceasing processing of the cash transfer of the record if there is a difference between the received information and the stored information.

43. The method of claim 42, comprising:
informing the party of the difference between the received information and the stored information.

44. The method of claim 41, further comprising:
flagging the record where there is a difference; and
informing the party of the difference.

45. The method of claim 41, further comprising:
if the received information and the stored information match, formatting the information in the at least one record into one of a plurality of formats based, at least in part, on a location of the bank account of the second entity related to the cash transfer of the record, to form a formatted record; and
sending a file comprising at least one formatted record to a clearing network.

46. A method of managing cash transfers by or on behalf of at least one first entity to a bank account of at least one respective second entity, the method comprising:
receiving information related to the cash transfer in the form of a file comprising at least one record related to a respective cash transfer, from a party;
sending the information to a clearing network to clear and settle the cash transfer;
receiving information from the clearing network concerning a status of the clearance and settlement of the cash transfer; and
informing the party of the status.

47. The method of claim 46, wherein a second party is contractually associated with the first party or the second party with respect to the cash transfer, the method further comprising:
informing the second party of the status.

48. The method of claim 46, comprising:
receiving the information from the clearing network in the form of at least one of a bank status message and a financial statement of account.

49. The method of claim 48, comprising:
informing the party of the steps of the clearance and settlement of the cash transfer through the clearance network, based, at least in part, on the bank status message and the financial statement of account.

50. A system for managing a cash transfer by or on behalf of a first entity to an account of a second entity, the system comprising:
means for receiving information related to the cash transfer; and
means for formatting the information into one of a plurality of formats based, at least in part, on a location of the account.

51. A system to manage a cash transfer by or on behalf of a first entity to an account of a second entity, the system comprising:
memory to store information related to the cash transfer; and
a processor coupled to the memory, the processor being programmed to:
format the information into one of a plurality of formats based, at least in part, on a location of the account.

52. The system of claim 51, wherein the account is a bank account and the processor is programmed to:
format the information into one of a plurality of formats based, at least in part, on a location of the bank account.

53. The system of claim 51, further comprising:
memory to store country specific formatting information related to a plurality of countries, the country specific formatting information being required to conduct the cash transfer in a respective country where the account is located;
wherein the processor is programmed to:
identify from the information related to the cash transfer a country of location of the account;
retrieve country specific formatting information for the country; and
modify the formatted information to conform to the country specific formatting information.

54. The system of claim 51, further comprising:
memory to store country specific information related to a plurality of countries, the country specific information being required to conduct the cash transfer in a respective country where the account is located;
wherein the processor is programmed to:
identify from the information related to the cash transfer a country of location of the account;
retrieve country specific information for the country from the memory; and
add the country specific information to the formatted information.

55. The system of claim 51, further comprising:
memory to store country specific formatting information related to a plurality of countries, the country specific formatting information being required to transfer the cash in a respective country where the account is located;
wherein the processor is programmed to:
identify from the information related to the cash transfer a country of location of the account;
retrieve country specific formatting information for the country from the memory; and
modify the formatted information to conform to the country specific formatting information.

56. The system of claim 51, further comprising:
memory to store times in a plurality of countries beyond which cash transfer cannot take place;
wherein the processor is programmed to:
identify from the information related to the cash transfer a country of location of the account;
retrieve the time information for the country from the memory; and
add the time to the formatted information.

57. The system of claim 51, further comprising:
memory to store value dates for money transfer in a plurality of countries, by which date money must be transferred into an account in that country;
wherein the processor is programmed to:
identify from the information related to the cash transfer a country of location of the account;
retrieve the value date information for the country from the memory; and
add the value date to the formatted information.

58. The system of claim 51, further comprising:
memory to store thresholds in a plurality of countries for monetary values above which a cash transfer must take place by wire transfer in a respective country;
wherein the processor is programmed to:
identify from the information related to the cash transfer a country of location of the account;
retrieve the threshold for the country from the memory; and
determine whether the cash transfer must be by wire transfer, based on the threshold; and
add an indication of whether the cash transfer must be by wire or not, to the formatted information based, at least in part, on the determination.

59. The system of claim 51, further comprising:
memory to store information related to a plurality of clearing networks that may be selected to clear and settle the cash transfer in a respective country;
wherein the processor is programmed to:
select one of the plurality of clearing networks to clear and settle the cash transfer, based, at least in part, on the stored information; and
add the selected clearing network to the formatted information.

60. The system of claim 59, wherein:
the memory stores at least one of fee, timing and capabilities information related to each of the plurality of clearing networks; and
wherein the processor is programmed to:
retrieve the at least one stored fee, timing and capabilities information from memory for the plurality of clearing networks;
compare the information; and
select one of the plurality of clearing networks to clear and settle the cash transfer, based, at least in part, on the comparison.

61. The system of claim 51, further comprising:
memory to store information related to the second entity provided prior to receiving the information related to the cash transfer;
wherein the processor is programmed to:
compare information about the second entity received with respect to the cash transfer to the previously received stored information.

62. The system of claim 61, wherein the processor is further programmed to:
cease processing of the cash transfer if there is a difference between the received information and the stored information.

63. The system of claim 61, wherein the information related to the second entity provided prior to receiving the information related to the cash transfer, is provided by a party, the processor being further programmed to:
inform the party of a difference between the received information and the stored information.

64. The system of claim 51, wherein the information relates to a plurality of cash transfers, and the information is provided in a file comprising a respective record for each cash transfer and a total amount of the cash transfers in all the records, the file being provided by a party, wherein:
the file is stored in the memory; and
the processor is programmed to:
sum the amounts of the cash transfers in each record;
compare the summed cash value to the total value;
reject the file if the summed value and the total value are different;
report the rejected file to the party.

65. The system of claim 51, wherein the processor is further programmed to:
analyze the information for data errors.

66. The system of claim 64, wherein the information relates to a plurality of cash transfers, each described in a respective record in a file provided by a party, wherein:
the file is stored in the memory; and
the processor is programmed to:
sum the number of records with an error;
compare the sum to a threshold; and
reject the file if the number of records with errors exceed the threshold; and
inform the party of an identity of the records with errors.

67. The system of claim 65, wherein the information relates to a plurality of cash transfers, each described in a respective record in a file provided by a party, wherein the processor is programmed to:
sum the number of records with an error;
compare the sum to a threshold;
if the number of records with errors is less than the threshold, remove the records with errors from the file if the number of records with errors is less than the threshold; and
inform the party of an identity of the records with errors.

68. The system of claim 51, wherein the processor is further programmed to:
send the formatted information to a clearing network to clear and settle the cash transfer.

69. The system of claim 68, wherein the processor is further to:
inform a party of the status of the clearance and settlement of the cash transfer, based on information received from a clearing network.

70. The system of claim 51, wherein the processor is further programmed to:
format the information based, at least in part, on a clearing network to be used to clear and settle the cash transfer.

71. The system of claim 51, wherein the processor is further programmed to:
format the information into a first format if the bank account is in the United States; and
format the information into a second format if the bank account is not in the United States.

72. A system to manage cash transfers by or on behalf of at least one first entity to a bank account of at least one respective second entity, the system comprising:
an interface to receive information related to the cash transfer in the form of a file, the file comprising at least one record related to a respective cash transfer, from a party;
memory to store the file;
a processor coupled to the interface and to the memory, the processor programmed to:
format the information in the at least one record into one of a plurality of formats based, at least in part, on a country where the bank account of the second entity related to the cash transfer of the record is located, to form a formatted record; and
send a file comprising at least one formatted record to a clearing network, via the interface.

73. The system of claim 72, wherein:
the memory stores information related to:
country specific information and country specific formatting information related to a plurality of countries, the country specific information and country specific formatting information being required to conduct the cash transfer in the country where the account is located;
times in a plurality of countries beyond which cash transfer cannot take place;
value dates for money transfer in a plurality of countries, by which date money must be transferred into an account in that country; and
thresholds in a plurality of countries for monetary values above which a cash transfer must take place by wire transfer in a respective country; and
the processor is further programmed to:
identify the country where the bank account is located, for a formatted record;
retrieve country specific information from the memory for the country;
add country specific information to a formatted record;
retrieve country specific formatting information from the memory for the country:
modify a formatted record to meet country specific formatting requirements of the country;
retrieve the time beyond which cash transfer cannot take place from the memory for the country;
add the time to the formatted information;
retrieve the value date information from the memory for the country;
add the value date to the formatted information;
retrieve the threshold from the memory for the country;
determine whether the cash transfer must be by wire transfer, based on the threshold; and
add an indication of an acceptable transfer mode to the formatted information, based, at least in part, on the determination.

74. The system of claim 72, wherein:
the memory stores information related to at least one of fees, timing and capabilities information of a plurality of clearing networks; and
the processor is programmed to:
retrieve the at least one of fees, timing and capabilities information for a plurality of clearing networks;
compare the information and
select one of a plurality of available clearing networks to clear and settle the cash transfer of a formatted record based, at least in part, on the comparison of the retrieved information.

75. The system of claim 72, wherein the processor is further programmed to:
analyze each record for data errors. sum the number of records with an error;
compare the sum to a threshold;
if the number of records with errors exceed the threshold, reject the file; and
inform the party of an identity of the records with errors; and
if the number of records with errors is less than the threshold, remove the records with errors from the file; and
inform the party of an identity of the records with errors.

76. The system of claim 72, wherein the processor is programmed to:
format the information into a first format if the bank account is in the United States; and
format the information into a second format if the bank account is not in the United States.

77. A system to manage cash transfers by or on behalf of at least one first entity to a bank account of at least one respective second entity, the system comprising:
an interface to receive:
information about a second entity, from a party; and
information related to the cash transfer in the form of a file comprising at least one record related to a respective cash transfer, from the party;
memory to store the information about the second entity and the information about the cash transfer; and
a processor coupled to the interface and to the memory, the processor being programmed to:
compare the information about the second entity to the information about the cash transfer to identify differences in the same type of information.

78. The system of claim 77, wherein the processor is further programmed to:
cease processing of the cash transfer of the record if there is a difference between the received information and the stored information; and
inform the party of the difference between the received information and the stored information.

79. The system of claim 77, wherein the processor is further programmed to:
flag the record where there is a difference; and
inform the party of the difference.

80. The system of claim 79, wherein the processor is further programmed to:
identify a country where the bank account of the second entity is located, based on the information related to the cash transfer, in a respective record;
format the information in the at least one record into one of a plurality of formats based, at least in part, on the country, to form a formatted record; and
send a file comprising at least one formatted record to a clearing network, via the interface.

81. A system to manage cash transfers by or on behalf of at least one first entity to a bank account of at least one respective second entity, the system comprising:
an interface to:
receive information related to the cash transfer in the form of a file comprising at least one record related to a respective cash transfer, from a party;
memory to store the received information; and
a processor coupled to the interface and to the memory, the processor being programmed to:
send the information to a clearing network to clear and settle the cash transfer; and
inform the party of a status of the clearance and settlement of the cash transfer based on information provided by the clearing network.

82. The system of claim 81, wherein a second party is contractually associated with the first entity or the second entity with respect to the cash transfer, and the processor is further programmed to:
inform the second party of the status.

83. The system of claim 81, wherein a second party is contractually associated with the first party or the second party with respect to the cash transfer, and the processor is further programmed to:
allow access to information about the status of the cash transfer by the second party.

84. A system to manage cash transfers by or on behalf of at least one first entity to a bank account of at least one respective second entity, the system comprising:
an interface to:
receive information related to the cash transfer in the form of a file comprising at least one record related to a respective cash transfer, from the party, and
memory to store the received information; and
a processor coupled to the interface and to the memory, the processor being programmed to:
process the record for cash transfer; and
allow access to information about the status of the processing of the record by the system, to at least one selected party.

85. The system of claim 84, wherein the processor is further programmed to:
send the information to a clearing network to clear and settle the cash transfer;
receive information from the clearing network concerning a status of the clearance and settlement of the cash transfer; and
allow access to information about the status of the processing of the record by the clearing network, to the at least one selected party.

86. The system of claim 85, wherein the selected party is contractually associated with the first party or the second party with respect to the cash transfer, the record comprises an identification of the selected party and the processor is further programmed to:
receive identification of the selected party from the party;
compare the identification with an identification of the selected party in the record; and
allow access if the identification of the selected party matches the identification in the record.

87. A method of managing cash transfers by or on behalf of at least one first entity to a bank account of at least one respective second entity, the method comprising:
receiving information related to a cash transfer in the form of a file comprising at least one record related to a respective cash transfer;
processing the record;
receiving a request for access to status information related to the status of the processing of the record; and
selectively granting access to the status information.

88. The method of claim 87, further comprising:
sending the record to a clearing network to clear and settle the cash transfer;
receiving information from the clearing network concerning a status of the clearance and settlement of the cash transfer; and
allowing access to information about the status of the processing of the record by the clearing network, to the at least one selected party.

88. The method of claim 87, wherein the selected party is contractually associated with the first party or the second party with respect to the cash transfer and the record comprises an identification of the selected party, the method further comprising:
receiving an identification of the selected party from the party;
comparing the identification with an identification of the selected party in the record; and
allowing access if the identification of the selected party matches the identification in the record.
